(19) United States
(12) Patent Application Publication
(10) Pub. No.: US 2022/0250937 A1
(43) Pub. Date: Aug. 11, 2022

(54) METHOD FOR MANUFACTURING POSITIVE ELECTRODE ACTIVE MATERIAL, SECONDARY BATTERY, AND VEHICLE

(71) Applicant: SEMICONDUCTOR ENERGY LABORATORY CO., LTD., Atsugi-shi (JP)

(72) Inventors: Shunpei YAMAZAKI, Tokyo (JP); Yusuke YOSHITANI, Isehara (JP); Takashi HIRAHARA, Atsugi (JP); Kunihiko SUZUKI, Isehara (JP); Kanta ABE, Atsugi (JP)

(21) Appl. No.: 17/587,819

(22) Filed: Jan. 28, 2022

(30) Foreign Application Priority Data
Feb. 5, 2021 (JP) 2021-017119

(51) Int. Cl. C01G 53/00; H01M 10/0525

(52) U.S. Cl. CPC C01G 53/44; H01M 2220/20; C01P 2006/40; H01M 10/0525

(57) ABSTRACT

A novel method for manufacturing a positive electrode active material is provided. In the method, an acid solution is formed by mixing an aqueous solution containing nickel, cobalt, and manganese with an aqueous solution containing a first additive element; a composite hydroxide containing nickel, cobalt, manganese, and the first additive element is formed by a reaction between the acid solution and an alkaline solution; the composite hydroxide and a lithium source are mixed and heated (first heating) to form a composite oxide; and the composite oxide and a second additive element source are mixed and heated (second heating). The first additive element is at least one of gallium, boron, aluminum, indium, magnesium, and fluorine, and the second additive element is at least one of calcium, gallium, boron, aluminum, indium, magnesium, and fluorine.

### BACKGROUND OF THE INVENTION

### 1. Field of the Invention

One embodiment of the present invention relates to an object, a method, or a manufacturing method. One embodiment of the present invention also relates to a process, a machine, manufacture, or a composition of matter. One embodiment of the present invention relates to a semiconductor device, a display device, a light-emitting device, a power storage device, a lighting device, an electronic device, or a manufacturing method thereof. In particular, one embodiment of the present invention relates to a positive electrode active material for a lithium-ion secondary battery and a method of manufacturing the positive electrode active material.

### 2. Description of the Related Art

In recent years, demand for lithium-ion secondary batteries with high output and high capacity has rapidly grown and the lithium-ion secondary batteries are essential as repeatedly-usable energy sources for today's information society.

In particular, lithium ion secondary batteries for portable electronic devices have been required to have a large discharge capacity per weight and superior charge and discharge characteristics. To meet the requirements, positive electrode active materials used in lithium-ion secondary batteries have been actively improved. For example, a positive electrode active material that has high charge and discharge characteristics is disclosed in Patent Document 1.

### REFERENCE

### [Patent Document 1] Japanese Published Patent Application No. 2017-107796

### SUMMARY OF THE INVENTION

Improvements of lithium-ion secondary batteries and positive electrode active materials used therein are desired in terms of capacity, cycle performance, charge and discharge characteristics, reliability, safety, cost, and the like.

In view of the above, an object of one embodiment of the present invention is to provide a positive electrode active material with little deterioration and a method for manufacturing the positive electrode active material. Another object of one embodiment of the present invention is to provide a low-cost positive electrode active material and a method for manufacturing the positive electrode active material. Another object of one embodiment of the present invention is to provide a positive electrode active material having a high proportion of nickel as a transition metal and a method for manufacturing the positive electrode active material. Another object of one embodiment of the present invention is to provide a positive electrode active material with superior charge and discharge characteristics and a method for manufacturing the positive electrode active material. Another object of one embodiment of the present invention is to provide a secondary battery with a high degree of safety and a method for manufacturing the secondary battery. Another object of one embodiment of the present invention is to provide a novel method for manufacturing a positive electrode active material.

The description of the above object does not disturb the existence of other objects. Other objects can be derived from the description of the specification, the drawings, and the claims. One embodiment of the present invention does not necessarily achieve all the objects described above, and achieve at least any one of all the objects described above.

To achieve any of the above-described objects, a positive electrode active material including an additive element is formed in one embodiment of the present invention. The additive element may be added in a step of forming a composite hydroxide serving as a precursor of a positive electrode active material or in a step of mixing the precursor and a lithium source. Alternatively, the additive element may be added in a step after a composite oxide containing lithium and a transition metal is formed. Alternatively, the additive element may be added in some steps of the above steps.

One embodiment of the present invention is a method for manufacturing a positive electrode active material. The method includes forming a composite hydroxide containing nickel, cobalt, and manganese by a reaction between an aqueous solution containing nickel, cobalt, and manganese and an alkaline solution; mixing the composite hydroxide, a lithium source, and a first additive element source; and performing heating. In the method, the first additive element is at least one of gallium, boron, aluminum, indium, magnesium, and fluorine.

In the above structure, preferably, the first additive element is gallium, and the first additive element source is gallium hydroxide, gallium oxyhydroxide, or an organic acid salt of gallium.

Another embodiment of the present invention is a method for manufacturing a positive electrode active material. The method includes forming a composite hydroxide containing nickel, cobalt, and manganese by a reaction between an aqueous solution containing nickel, cobalt, and manganese and an alkaline solution; mixing the composite hydroxide and a lithium source and performing first heating to form a composite oxide; mixing the composite oxide and a first additive element source; and performing second heating. In the method, the first additive element is at least one of calcium, gallium, boron, aluminum, indium, magnesium, and fluorine.

In the above structure, the second heating is preferably performed at a temperature higher than 750° C. and lower than or equal to 850° C.

In the above structure, preferably, the first additive element is gallium, and a compound containing the first additive element is gallium hydroxide, gallium oxyhydroxide, or an organic acid salt of gallium.

Another embodiment of the present invention is a method for manufacturing a positive electrode active material. The method includes mixing an aqueous solution containing nickel, cobalt, and manganese, and an aqueous solution containing a first additive element to form an acid solution; forming a composite hydroxide containing nickel, cobalt, manganese, and the first additive element by a reaction between the acid solution and an alkaline solution; mixing the composite hydroxide and a lithium source and performing first heating to form a composite oxide; mixing the composite oxide and a second additive element source; and performing second heating. In the method, the first additive element is at least one of gallium, boron, aluminum, indium, magnesium, and fluorine, and the second additive element is at least one of calcium, gallium, boron, aluminum, indium, magnesium, and fluorine.

In the above structure, the second heating is preferably performed at a temperature higher than 750° C. and lower than or equal to 850° C.

In the above structure, preferably, the first additive element is gallium, the first additive element source is gallium hydroxide, gallium oxyhydroxide, or an organic acid salt of gallium, the second additive element is calcium, and the second additive element source is calcium carbonate or calcium fluoride.

Another embodiment of the present invention is a secondary battery including the positive electrode active material manufactured by any of the above methods.

Another embodiment of the present invention is a vehicle including the secondary battery including the positive electrode active material manufactured by any of the above methods, and at least one of a motor, a brake, and a control circuit.

One embodiment of the present invention can provide a positive electrode active material with little deterioration and a method for manufacturing the positive electrode active material. Another embodiment of the present invention can provide a low-cost positive electrode active material and a method for manufacturing the positive electrode active material. Another embodiment of the present invention can provide a positive electrode active material having a high proportion of nickel as a transition metal and a method for manufacturing the positive electrode active material. Another embodiment of the present invention can provide a positive electrode active material with superior charge and discharge characteristics and a method for manufacturing the positive electrode active material. Another embodiment of the present invention can provide a secondary battery with a high degree of safety and a method for manufacturing the secondary battery. Another embodiment of the present invention can provide a novel method for manufacturing a positive electrode active material.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIG. 1 is a flow chart illustrating a method for manufacturing a positive electrode active material;

FIG. 2 is a flow chart illustrating a method for manufacturing a positive electrode active material;

FIG. 3 is a flow chart illustrating a method for manufacturing a positive electrode active material;

FIG. 4 is a flow chart illustrating a method for manufacturing a positive electrode active material;

FIG. 5 is a flow chart illustrating a method for manufacturing a positive electrode active material;

FIG. 6 is a flow chart illustrating a method for manufacturing a positive electrode active material;

FIG. 7 is a flow chart illustrating a method for manufacturing a positive electrode active material;

FIG. 8 is a flow chart illustrating a method for manufacturing a positive electrode active material;

FIG. 9 is a diagram illustrating coprecipitation synthesis equipment;

FIG. 10 is a diagram illustrating coprecipitation synthesis equipment;

FIG. 11 is a diagram illustrating a calculation model;

FIG. 12 is a graph showing calculation results;

FIGS. 13A to 13D are diagrams showing a calculation model;

FIGS. 14A and 14B are illustrations of calculation results;

FIG. 15A is an exploded perspective view of a coin-type secondary battery, FIG. 15B is a perspective view of the coin-type secondary battery, and FIG. 15C is a cross-sectional perspective view of the coin-type secondary battery;

FIGS. 16A and 16B illustrate examples of a cylindrical secondary battery; FIG. 16C illustrates an example of a plurality of cylindrical secondary batteries, and FIG. 16D illustrates an example of a power storage system including a plurality of cylindrical secondary batteries;

FIGS. 17A and 17B illustrate examples of a secondary battery, and FIG. 17C illustrates the internal state of the secondary battery;

FIGS. 18A to 18C illustrate an example of a secondary battery;

FIGS. 19A and 19B each illustrate the appearance of a secondary battery;

FIGS. 20A to 20C illustrate a manufacturing method of a secondary battery;

FIGS. 21A to 21C illustrate structure examples of a battery pack;

FIGS. 22A and 22B illustrate examples of secondary batteries;

FIGS. 23A to 23C illustrate an example of a secondary battery;

FIGS. 24A and 24B illustrate an example of a secondary battery;

FIG. 25A is a perspective view of a battery pack, FIG. 25B is a block diagram of the battery pack, and FIG. 25C is a block diagram of a vehicle including the battery pack and a motor;

FIGS. 26A to 26D illustrate examples of transport vehicles;

FIGS. 27A and 27B each illustrate a power storage device;

FIG. 28A illustrates an electric bicycle, FIG. 28B illustrates a secondary battery of an electric bicycle, and FIG. 28C illustrates an electric motorcycle;

FIGS. 29A to 29D each illustrate an example of an electronic device;

FIG. 30A illustrates examples of wearable devices, FIG. 30B is a perspective view of a watch-type device, FIG. 30C illustrates a side surface of a watch-type device, and FIG. 30D illustrates an example of wireless earphones;

FIGS. 31A and 31B are cross-sectional SEM images of positive electrode active materials;

FIGS. 32A and 32B are cross-sectional SEM images of positive electrode active materials;

FIG. 33A is a graph showing relationships between charge-discharge cycle and discharge capacity and FIG. 33B is a graph showing relationships between charge-discharge cycle and discharge capacity retention rate; and

FIG. 34A is a graph showing relationships between charge-discharge cycle and discharge capacity and FIG. 34B is a graph showing relationships between charge-discharge cycle and discharge capacity retention rate.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly contain a substance that does not contribute to the charge and discharge capacity.

In this specification and the like, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex.

In this specification, the term “crack” refers to not only a crack caused in the manufacturing process of a positive electrode active material, but also a crack caused by application of pressure, charge and discharge, and the like after the manufacturing process.

In this specification and the like, a superficial portion of a particle of an active material and the like is, for example, a region of 50 nm or less, preferably 35 nm or less, further preferably 20 nm or less, still further preferably 10 nm or less in depth from the surface toward an inner portion. A plane caused by a crack can be regarded as a surface. A region at a position deeper than the superficial portion is referred to as an inner portion. In this case, as the particle of an active material and the like, either a primary particle or a secondary particle is acceptable.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

In this specification and the like, an approximate value of a given value A refers to a value greater than or equal to 0.9×A and less than or equal to 1.1×A.

### Embodiment 1

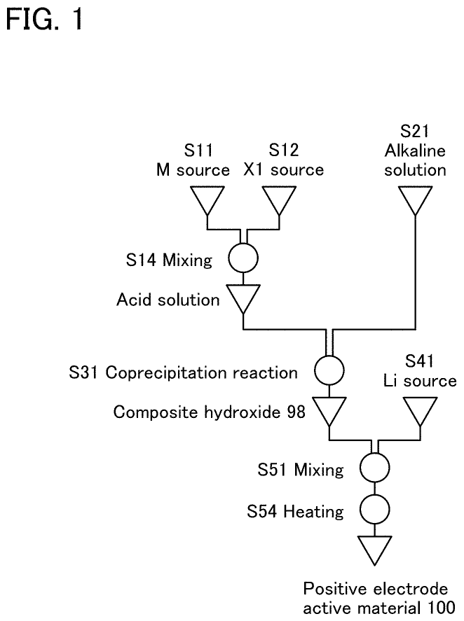

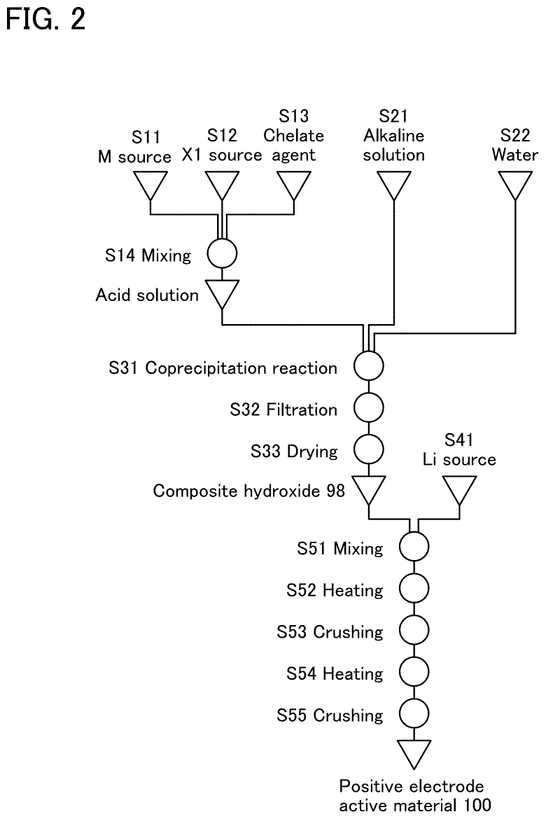

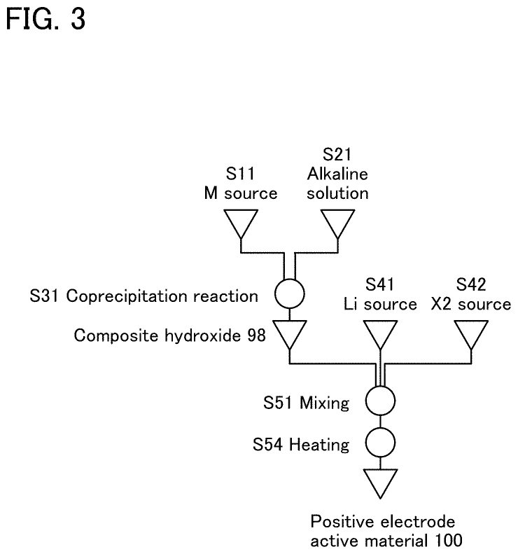

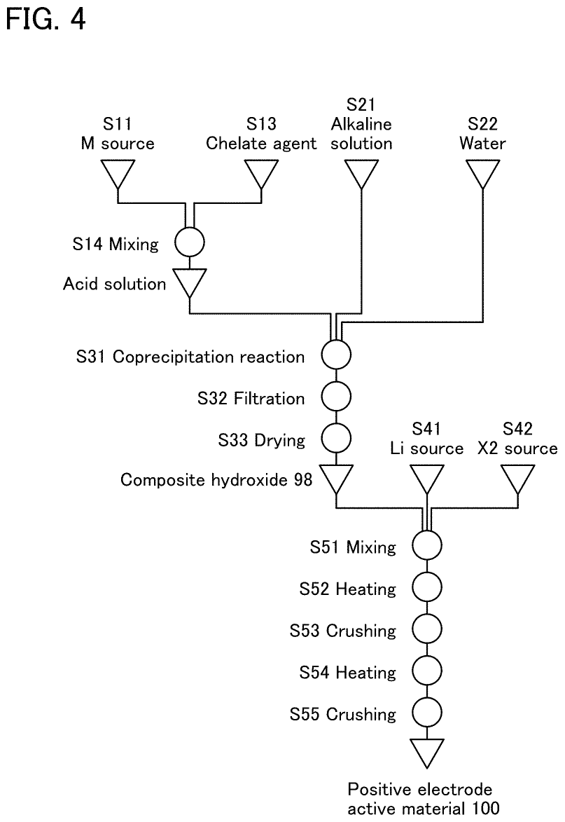

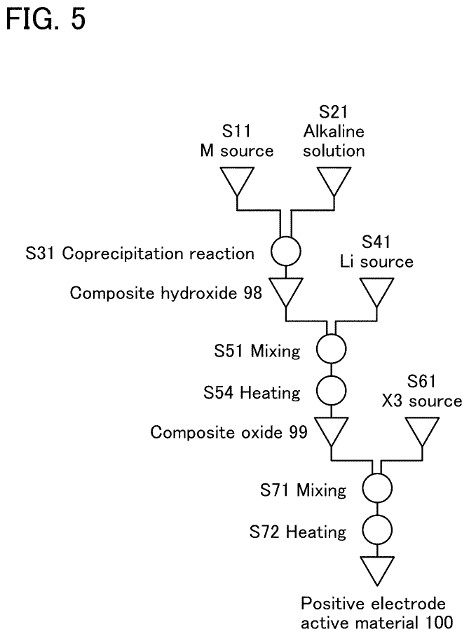

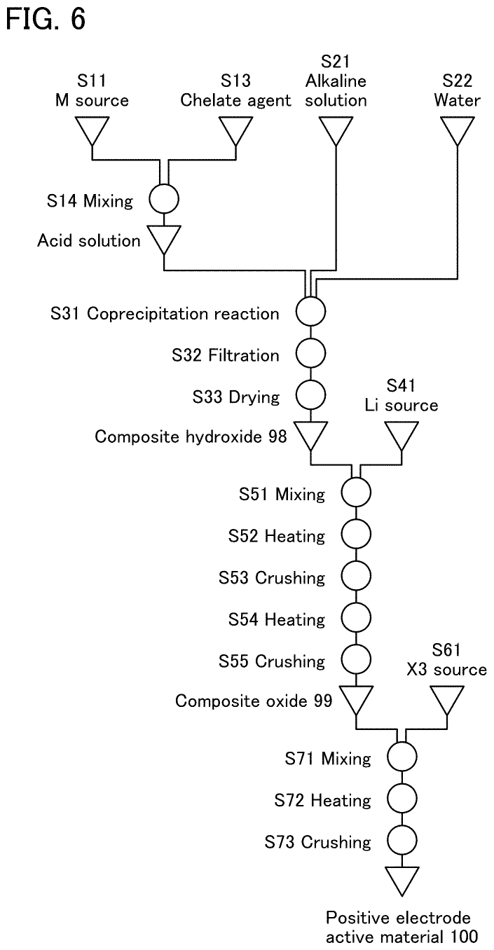

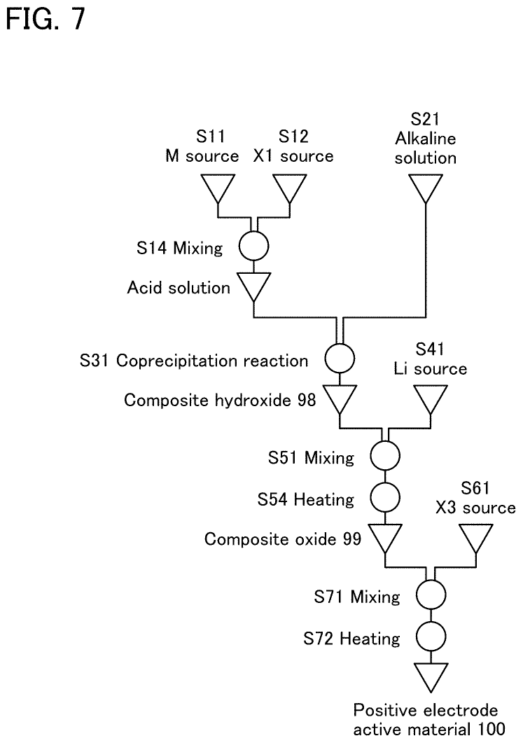

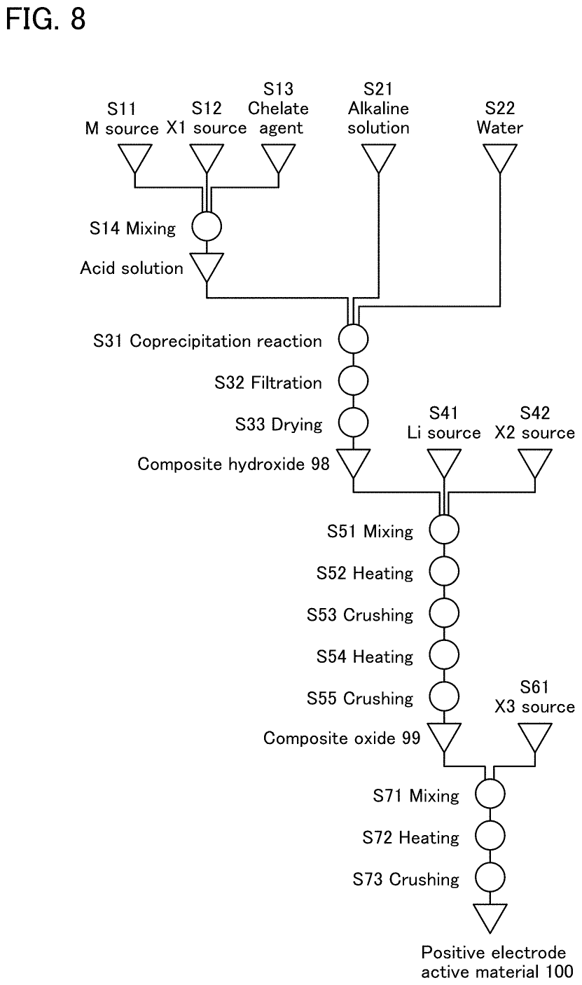

This embodiment will describe an example of a manufacturing method of a positive electrode active material 100 that is one embodiment of the present invention with reference to FIG. 1, FIG. 2, FIG. 3, FIG. 4, FIG. 5, FIG. 6, FIG. 7, and FIG. 8

Note that flow charts illustrated in FIG. 1, FIG. 2, FIG. 3, FIG. 4, FIG. 5, FIG. 6, FIG. 7, and FIG. 8 show the order of steps that are connected by lines. The flow chart does not show timing for the steps not directly connected by lines. For example, Step S11 and Step S21 in FIG. 1 are written at the same level in the drawing; however, Step S11 and Step S21 are not necessarily performed at the same time.

### [Manufacturing Method 1]

First is described a method for adding an additive element X1 in formation of a composite hydroxide 98 serving as a precursor of the positive electrode active material 100, with reference to FIG. 1 and FIG. 2.

### <Step S11>

In Step S11 in FIG. 1 and FIG. 2, a transition metal M source is prepared first.

As the transition metal M, at least one of nickel, cobalt, and manganese can be used, for instance. The transition metal M refers to, for example, nickel alone; two elements of cobalt and manganese; two elements of cobalt and nickel; or three elements of cobalt, manganese, and nickel.

When at least one of nickel, cobalt, and manganese is used, the mixed ratio of nickel, cobalt, and manganese is preferably set such that a layered rock-salt crystal structure can be formed.

In particular, a large amount of nickel is preferably included as the transition metal Min the positive electrode active material 100, in which case the cost of the source material may be lower than that in the case of using a large amount of cobalt and charge and discharge capacity per weight may be increased. For example, the proportion of nickel used as the transition metal M preferably exceeds 25 atomic %, is more preferably 60 atomic % or higher, and is still further preferably 80 atomic % or higher. However, when the proportion of nickel is too high, the chemical stability and heat resistance might decrease. Therefore, the proportion of nickel used as the transition metal M is preferably 95 atomic % or lower.

Cobalt is preferably contained as the transition metal M, in which case the average discharging voltage is high and a secondary battery can be highly reliable because cobalt contributes to stabilization of the layered rock-salt structure. Meanwhile, the price of cobalt is higher or more unstable than those of nickel and manganese; thus, a too high proportion of cobalt might increase the cost for manufacturing the secondary battery. For this reason, the proportion of cobalt used as the transition metal M is preferably higher than or equal to 2.5 atomic % and lower than or equal to 34 atomic %.

Note that cobalt is not necessarily contained as the transition metal M.

Manganese is preferably contained as the transition metal M, in which case the heat resistance and chemical stability are improved. However, a too high proportion of manganese tends to decrease a discharging voltage and a discharge capacity. For this reason, the proportion of manganese used as the transition metal M is preferably higher than or equal to 2.5 atomic % and lower than or equal to 34 atomic %.

Note that manganese is not necessarily contained as the transition metal M.

As the transition metal M source, an aqueous solution containing the transition metal M is prepared. As a nickel source, an aqueous solution of nickel salt can be used. As the nickel salt, nickel sulfate, nickel chloride, nickel nitrate, or a hydrate thereof can be used, for example. Furthermore, an organic acid salt of nickel typified by nickel acetate or a hydrate thereof can also be used. As the nickel source, an aqueous solution of nickel alkoxide or an organic nickel complex can also be used. In this specification and the like, the term “organic acid salt” denotes a compound of a metal and an organic acid such as an acetic acid, a citric acid, an oxalic acid, a formic acid, or a butyric acid.

Similarly, an aqueous solution of cobalt salt can be used as a cobalt source. As the cobalt salt, cobalt sulfate, cobalt chloride, cobalt nitrate, or a hydrate thereof can be used, for example. Furthermore, an organic acid salt of cobalt typified by cobalt acetate or a hydrate thereof can also be used. As the cobalt source, an aqueous solution of cobalt alkoxide or an organic cobalt complex can be used.

Similarly, an aqueous solution of manganese salt can be used as a manganese source. As the manganese salt, manganese sulfate, manganese chloride, manganese nitrate, or a hydrate thereof can be used. Furthermore, an organic acid salt of manganese typified by manganese acetate or a hydrate thereof can also be used. As the manganese source, an aqueous solution of manganese alkoxide or an organic manganese complex can be used.

In this embodiment, an aqueous solution in which nickel sulfate, cobalt sulfate, and manganese sulfate are dissolved in pure water is prepared as the transition metal M source. In this case, the atomic ratio of nickel, cobalt, and manganese is expressed by Ni:Co:Mn=8:1:1 or in the neighborhood thereof. The aqueous solution is acidic.

### <Step S12>

In Step S12 in FIG. 1 and FIG. 2, an additive element X1 source is prepared.

As the additive element X1, for example, at least one of gallium, boron, aluminum, indium, fluorine, magnesium, titanium, yttrium, zirconium, niobium, lanthanum, and hafnium can be used. The additive element X1 can be, for example, gallium alone; two elements of gallium and aluminum; or three elements of gallium, boron, and aluminum.

As the additive element X1 source, an aqueous solution containing the additive element X1 is prepared. As a gallium source, for example, an aqueous solution of gallium hydroxide or gallium salt can be used. Examples of the gallium salt include gallium sulfate, gallium acetate, and gallium nitrate.

As a boron source, for example, an aqueous solution of boric acid or borate can be used.

As an aluminum source, for example, an aqueous solution of aluminum hydroxide or aluminum salt can be used. Examples of aluminum salt include aluminum sulfate, aluminum acetate, and aluminum nitrate.

As an indium source, for example, an aqueous solution of indium hydroxide or indium salt can be used. Examples of indium salt include indium sulfate, indium acetate, and indium nitrate.

As a fluorine source, for example, an aqueous solution of gallium fluoride, boron fluoride, aluminum fluoride, or magnesium fluoride can be used.

As the magnesium source, for example, an aqueous solution of magnesium hydroxide, magnesium carbonate, or magnesium fluoride can be used.

In this embodiment, gallium is used as the additive element X1, and an aqueous solution in which gallium sulfate is dissolved in pure water is prepared as the additive element X1 source.

### <Step S13>

In illustrated in Step S13 in FIG. 2, a chelate agent may be prepared. Examples of the chelate agent include glycine, oxine, 1-nitroso-2-naphthol, 2-mercaptobenzothiazole, and EDTA (ethylenediaminetetraacetic acid). Some kinds selected from glycine, oxine, 1-nitroso-2-naphthol, 2-mercaptobenzothiazole, and EDTA can be used. At least one of the chelate agents is dissolved in pure water to form a chelate solution. The chelate agent serves as a complexing agent to form a chelate compound, and is preferred to a general complexing agent. Needless to say, such a complexing agent may be used instead of the chelate agent, and ammonia water can be used as the complexing agent.

The chelate solution is preferably used, in which case generation of unnecessary crystal nuclei is suppressed to promote the crystal growth. Since generation of unnecessary crystal nuclei is suppressed to inhibit generation of fine particles, a composite hydroxide with good particle size distribution can be obtained. Furthermore, the use of the chelate solution can slow an acid-base reaction, so that the reaction gradually progresses to form a nearly spherical secondary particle. Glycine can maintain the pH at 9.0 to 10.0, inclusive, or in the neighborhood thereof. Thus, a glycine solution is preferably used as the chelate solution, in which case the pH in the reaction vessel can be controlled in the formation of the composite hydroxide 98. In addition, the glycine concentration of the glycine solution is preferably higher than or equal to 0.05 mol/L and lower than or equal to 0.5 mol/L, further preferably higher than or equal to 0.1 mol/L and lower than or equal to 0.2 mol/L.

### <Step S14>

Next, in Step S14 in FIG. 1, the transition metal M source and the additive element X1 source are mixed, so that an acid solution is formed. A chelate agent may be further mixed as illustrated in FIG. 2.

When the proportion of the additive element X1 to the transition metal M is too low, the effect of suppressing deterioration of the positive electrode active material 100 or the effect of improving the charge and discharge characteristics is not sufficient. In contrast, a too high proportion of the additive element X1 can cause disadvantages such as a reduction in the charge and discharge capacity of the positive electrode active material 100 and a rise in the cost. Therefore, it is preferable that the sum of elements used as the additive element X1 to the sum of all elements used as the transition metal M and the additive element X1 be 10 atomic % or lower, in the mixing. More preferably, the additive element X1 is mixed at greater than or equal to 1 atomic % and less than or equal to 4 atomic %. In other words, when the atomic ratio is (M+X1):X1=1:A, A≤0.1 is preferred, and 0.01≤A≤0.04 is more preferred.

In this embodiment, when the atomic ratio of nickel, cobalt, manganese, and gallium is Ni:Co:Mn:Ga=80:10:(10−x):x, gallium is mixed so that x is within the range from 1 to 4 (1≤x≤4).

### <Step S21>

Next, in Step S21 in FIG. 1 and FIG. 2, an alkaline solution is prepared. As the alkaline solution, an aqueous solution containing sodium hydroxide, potassium hydroxide, lithium hydroxide, or ammonia can be used. An aqueous solution in which any of these substances is dissolved in pure water can be used. Alternatively, an aqueous solution in which multiple kinds selected from sodium hydroxide, potassium hydroxide, lithium hydroxide, and ammonia are dissolved in pure water may be used.

The pure water that is preferably used for the transition metal M source, the additive element X1 source, and the alkaline solution is water with a resistivity of 1 MΩ·cm or higher, preferably 10 Ma cm or higher, further preferably 15 MΩ·cm or higher. Water with the above-described resistivity has high purity and an extremely small amount of impurities.

### <Step S22>

As illustrated in Step S22 in FIG. 2, water is preferably prepared in a reaction vessel. The water may be pure water, and an aqueous solution of a chelate agent is more preferable. Thus, the water can be referred to as a chelate solution, a filling liquid in the reaction vessel, or an adjustment liquid. The description regarding Step S13 can be referred to for the chelate solution.

### <Step S31>

Next, in Step S31 in FIG. 1 and FIG. 2, an acid solution and an alkaline solution are mixed to be reacted with each other. The reaction can be referred to as a coprecipitation reaction, a neutralization reaction, or an acid-base reaction.

During the coprecipitation reaction of Step S31, the pH of the reaction system is preferably higher than or equal to 9.0 and lower than or equal to 11.0, further preferably higher than or equal to 9.8 and lower than or equal to 10.3.

For example, when an alkaline solution is put in a reaction vessel and an acid solution is dropped into the reaction vessel, the pH of the aqueous solution in the reaction vessel is preferably kept in the above range. Similarly, the same applies to a case where the acid solution is put in the reaction vessel and the alkaline solution is dropped thereinto. The dropping rate of the acid solution or the alkaline solution is preferably higher than or equal to 0.01 mL/min and lower than or equal to 1 mL/min, further preferably higher than or equal to 0.1 mL/min and lower than or equal to 0.8 mL/min when 200 mL to 350 mL of the solution is in the reaction vessel, in which case the pH conditions can be easily controlled. The reaction vessel contains a reaction container or the like.

The aqueous solution in the reaction vessel is preferably stirred with a stirring means. The stirring means includes a stirrer, an impeller, or the like. The impeller can have two to six blades, for example, when an impeller with four blades is employed, the four blades may be arranged to make a cross shape seen from above. The rotation number of the stirring means may be from 800 rpm to 1200 rpm, inclusive.

The temperature of the reaction vessel is preferably controlled to be higher than or equal to 50° C. and lower than or equal to 90° C. After the temperature of the reaction vessel falls within the above temperature range, dropping of the alkaline solution or the acid solution is preferably started.

The reaction vessel preferably has an inert atmosphere. Nitrogen or argon can be used as the inert atmosphere. In the case of the nitrogen atmosphere, a nitrogen gas may be introduced at a flow rate of 0.5 L/min to 2 L/min, inclusive.

In the reaction vessel, a reflux condenser is preferably placed. The nitrogen gas can be released from the reaction vessel and water can be returned to the reaction vessel with use of the reflux condenser.

Through above-described coprecipitation reaction, the composite hydroxide 98 having the transition metal M and the addition element X1 is precipitated.

### <Step S32>

Filtration is preferably performed to collect the composite hydroxide 98 as in Step S32 in FIG. 2. Suction filtration is preferred for the filtration. The filtration is preferably performed after a reaction product precipitated in the reaction vessel is washed with pure water, and then an organic solvent with a low boiling point (e.g., acetone) is added thereto.

### <Step S33>

As illustrated in Step S33 in FIG. 2, the composite hydroxide 98 after the filtration is preferably dried. For example, the composite hydroxide 98 is dried in a vacuum at higher than or equal to 60° C. and lower than or equal to 90° C. for longer than or equal to 0.5 hours and shorter than or equal to 3 hours. In this manner, the composite hydroxide 98 can be obtained.

In this manner, the composite hydroxide 98 containing the transition metal M and the addition element X1 can be obtained. In this specification and the like, the composite hydroxide 98 denotes a hydroxide of a plurality of metals. The composite hydroxide 98 can be referred to as a precursor of the positive electrode active material 100.

The composite hydroxide 98 can be obtained as a secondary particle in which primary particles are aggregated. Note that in this specification, the primary particle refers to a particle (lump) as a minimum unit without grain boundaries in its inner portion when being observed, e.g., at a magnification of 5000 times with a scanning electron microscope (SEM), for example. In other words, the primary particle means a minimum unit of particle surrounded by a grain boundary of a secondary particle. The secondary particle refers to a particle in which the primary particles are aggregated, partially sharing the grain boundary of the secondary particle (the circumference of the primary particle or the like) and are not easily separated from each other (but independent of each other). That is, the secondary particle has a grain boundary in some cases.

### <Step S41>

Next, a lithium source is prepared in Step S41 in FIG. 1 and FIG. 2. As the lithium source, for example, lithium hydroxide, lithium carbonate, or lithium nitrate can be used. In particular, a material having a low melting point among lithium compounds, such as lithium hydroxide with the melting point of 462° C., is preferably used. Since a positive electrode active material containing nickel at a high proportion easily causes cation mixing as compared with lithium cobalt oxide or the like, heating in Step S54 and the like needs to be performed at low temperatures. Therefore, it is preferable to use a material having a low melting point.

As the lithium source, a high-purity material is preferably used. Specifically, the purity of the material is 4N (99.99%) or higher, preferably 4N5 (99.995%) or higher, more preferably 5N (99.999%) or higher. Using a material with a high purity can improve the battery characteristics of the secondary battery.

### <Step S51>

Next, in Step S51 in FIG. 1 and FIG. 2, the composite hydroxide 98 and the lithium source are mixed. The mixing can be performed by a dry method or a wet method. For example, a ball mill or a bead mill can be used for the mixing. When a ball mill is used, zirconia balls are preferably used as media, for example. When a ball mill, a bead mill, or the like is used, the peripheral speed is preferably greater than or equal to 100 mm/s and less than or equal to 2000 mm/s in order to inhibit contamination from the media or the material. The cobalt compound and the lithium compound are sometimes pulverized during the mixing.

### <Step S52 to Step S55>

Next, heating is performed on the mixture of the composite hydroxide 98 and the lithium source. The heating may be performed once as in Step S54 in FIG. 1; however, heating is preferably performed twice as in Step S52 and Step S54 in FIG. 2. Although not illustrated, heating may be performed three times or more.

The heating in Step S52 and the heating in Step S54 in FIG. 2 may be sometimes referred to as first heating and second heating, respectively, in distinction from another heating step.

An electric furnace or a rotary kiln furnace can be used as a firing device for the heating. A container such as a crucible, a sagger, or a setter used in the heating is preferably made of a material that hardly releases impurities. For example, a crucible made of aluminum oxide with a purity of 99.9% can be used. In the case of mass production, a sagger made of mullite cordierite (Al₂O₃.SiO₂.MgO) can be used, for example. Such a container is preferably heated with the lid on.

In the case where heating in Step S52 is performed as in FIG. 2, the heating temperature is preferably higher than or equal to 400° C. and lower than or equal to 700° C. The time for heating in Step S52 is preferably longer than or equal to 1 hour and shorter than or equal to 10 hours. The heating in Step S52 is preferably performed at a lower temperature and/or a shorter time than those of the heating in Step S54 performed later.

The heating atmosphere is preferably an oxygen atmosphere or an oxygen-containing atmosphere that is dry air with few moisture (e.g., with a dew point lower than or equal to −50° C., preferably lower than or equal to −80° C.).

For example, in the case where the heating is performed at 850° C. for 2 hours, the temperature rising rate is preferably higher than or equal to 150° C./h and lower than or equal to 250° C./h. The flow rate of dry air that forms a dry atmosphere is preferably higher than or equal to 8 L/min and lower than or equal to 15 L/min. The temperature decreasing time from a specified temperature to room temperature is preferably longer than or equal to 10 hours and shorter than or equal to 50 hours. The temperature decreasing rate can be calculated from the temperature decreasing time or the like.

By the heating of Step S52, gas components in the composite hydroxide 98 and the lithium source are expected to be released, and the composite oxide with fewer impurities can be formed with the use of the composite hydroxide 98 and the lithium source.

Furthermore, as illustrated in Step S53 and Step S55 in FIG. 2, crushing steps are preferably performed after the heating. The crushing can be performed in a mortar, for example. Furthermore, classification may be performed using a sieve. With the crushing step, the grain size and/or the shape of the positive electrode active material 100 can be uniformized.

The heating in Step S54 in FIG. 1 and FIG. 2 is preferably performed at a temperature higher than 700° C. and lower than or equal to 1050° C., further preferably higher than or equal to 800° C. and lower than or equal to 1000° C., still further preferably higher than or equal to 800° C. and lower than or equal to 950° C. It is important to heat the source materials at least at temperatures high enough to melt the source materials in manufacturing the positive electrode active material 100 through this heating.

The heating time can be longer than or equal to 1 hour and shorter than or equal to 100 hours, for example, and is preferably longer than or equal to 2 hours and shorter than or equal to 20 hours.

The heating atmosphere, the temperature rising rate, the temperature decreasing time, and the like can be referred to for the description of Step S52.

The heated material is preferably collected after being moved from the crucible to a mortar, in which case impurities are not mixed into the heated material. The mortar is preferably made of a material that hardly releases impurities, specifically, a mortar made of aluminum oxide with the purity of 90% or higher, preferably 99% or higher is suitably used.

Through the above process, the positive electrode active material 100 can be formed.

The positive electrode active material 100 is preferred in containing few impurities. However, sulfur might be detected from the positive electrode active material 100, when a sulfide is used as a staring material in the transition metal M source or the like. With use of glow discharge mass spectrometry (GD-MS), inductively coupled plasma-mass spectrometry (ICP-MS), or the like, elements of particles of contained in the positive electrode active material 100 can be analyzed to measure the concentration of sulfur.

### [Manufacturing Method 2]

Next, a method for adding an additive element X2 in the mixing of the composite hydroxide 98 and the lithium source is described with reference to FIG. 3 and FIG. 4. Steps different from those in FIG. 1 and FIG. 2 are mainly described, and for the other steps, the description regarding FIG. 1 and FIG. 2 can be referred to.

### <Step S11 to Step S41>

The composite hydroxide 98 containing the transition metal M is obtained through the steps similar to Step S11 to Step S31 in FIG. 1 and FIG. 2, except that the additive element X1 is not used. The lithium source is prepared as in Step S41 in FIG. 1 and FIG. 2.

### <Step S42>

Next, in Step S42 in FIG. 3 and FIG. 4, an additive element X2 source is prepared.

As the additive element X2, for example, at least one of gallium, boron, aluminum, indium, fluorine, magnesium, titanium, yttrium, zirconium, niobium, lanthanum, and hafnium can be used. The additive element X2 can be, for example, gallium alone; two elements of gallium and aluminum; or three elements of gallium, boron, and aluminum. The additive element X2 source is not necessarily an aqueous solution of any of the elements.

For example, gallium oxide, gallium oxyhydroxide, gallium hydroxide, or gallium salt can be used as the gallium source. Examples of the gallium source include gallium sulfate, gallium acetate, and gallium nitrate. Gallium alkoxide can also be used.

As the boron source, for example, boric acid or a borate can be used.

As the aluminum source, aluminum oxide, aluminum hydroxide, or aluminum salt can be used, for example. Examples of aluminum salt include aluminum sulfate, aluminum acetate, and aluminum nitrate. Aluminum alkoxide can also be used.

As the indium source, indium oxide, indium sulfate, indium acetate, or indium nitrate can be used, for example. Indium alkoxide can also be used.

As the fluorine source, gallium fluoride, boron fluoride, aluminum fluoride, or magnesium fluoride can be used.

As the magnesium source, magnesium oxide, magnesium hydroxide, magnesium carbonate, or magnesium fluoride can be used, for example. Magnesium alkoxide can also be used.

In this embodiment, gallium is used as the additive element X2, and gallium oxide hydroxide is prepared as the additive element X2 source.

### <Step S51 to Step S55>

After that, the positive electrode active material 100 can be formed through steps such as heating as in Step S51 to S55 in FIG. 1 and FIG. 2.

### [Manufacturing Method 3]

Next, a method for adding an additive element X3 after the formation of a composite oxide 99 containing lithium and the transition metal M is described with reference to FIG. 5 and FIG. 6. Steps different from those in FIG. 1, FIG. 2, FIG. 3, and FIG. 4 are mainly described, and for the other steps, the descriptions regarding FIG. 1, FIG. 2, FIG. 3, and FIG. 4 can be referred to.

### <Step S11 to Step S55>

In the steps similar to Step S11 to Step S33 in FIG. 3 and FIG. 4, the composite hydroxide 98 containing the transition metal M is obtained. After that, in the steps similar to Step S41 to Step S54 in FIG. 1 and FIG. 2, steps such as heating are performed on the composite hydroxide 98 and the lithium source. Crushing is preferably performed after the heating, as illustrated in Step S55 in FIG. 2.

The product obtained through the above steps is referred to as the composite oxide 99 in this manufacturing method as illustrated in FIG. 5 and FIG. 6.

### <Step S61>

Next, the additive element X3 source is prepared in Step S61 in FIG. 5 and FIG. 6.

As the additive element X3, for example, at least one of calcium, gallium, boron, aluminum, indium, fluorine, magnesium, titanium, yttrium, zirconium, niobium, lanthanum, and hafnium can be used. The additive element X3 can be, for example, calcium alone; gallium alone; aluminum alone; two elements of calcium and gallium; two elements of calcium and aluminum; or three elements of calcium, gallium, and aluminum.

Preferably, the additive element X3 source contains no water or is a material that contains less water than the additive element X1 source in order to inhibit the reaction between the composite oxide 99 and water.

As the calcium source, calcium oxide, calcium hydroxide, or calcium salt can be used, for example. As the calcium salt, calcium carbonate, calcium fluoride, or the like can be given.

For example, titanium oxide or titanium salt can be used as the titanium source. As the titanium salt, for example, titanium fluoride, titanium sulfate, titanium acetate, titanium nitrate, and the like can be given. Titanium alkoxide can also be used.

For example, as a zirconium source, zirconium oxide or zirconium salt can be used. Examples of the zirconium salt include zirconium fluoride, zirconium sulfate, zirconium acetate, and zirconium nitrate. Zirconium alkoxide can also be used

For the gallium source, the boron source, the aluminum source, the indium source, the fluorine source, and the magnesium source, any of materials similar to the additive element X2 can be used.

### <Step S71>

Next, the composite oxide 99 and the additive element X3 source are mixed in Step S71 in FIG. 5 and FIG. 6. This mixing can be performed in a manner similar to that of Step S51.

### <Step S72>

Next, a mixture of the composite oxide 99 and the additive element X3 source is heated in Step S72 in FIG. 5 and FIG. 6.

The heating of Step S72 is preferably performed at the temperature higher than or equal to 700° C. and lower than 1050° C., further preferably higher than or equal to 750° C. and lower than or equal to 850° C. The heating time can be longer than or equal to 1 hour and shorter than or equal to 100 hours, for example, and is preferably longer than or equal to 2 hours and shorter than or equal to 10 hours. The heating of Step S72 is preferably performed at a lower temperature and/or for a shorter heating time than those of Step S54.

The heating atmosphere, the temperature rising rate, the temperature decreasing time, and other conditions can be referred to for the description of Step S54.

### <Step S73>

As illustrated in Step S73 in FIG. 6, a crushing step is preferably performed after the heating. The crushing can be performed in a manner similar to those of Step S53 and Step S55.

Through the above process, the positive electrode active material 100 can be formed.

As performed in the manufacturing method in FIG. 5 and FIG. 6, the composite oxide 99 is formed, the additive element X3 source is mixed thereto, and the mixture is heated, whereby concentration profiles in the depth direction of the elements contained in the positive electrode active material 100 can be varied in some cases. For example, the concentration of the additive element X3 can be made higher in the superficial portion than in the inner portion of the positive electrode active material 100. Accordingly, the effect of the additive element that contributes to stabilization of the superficial portion can be increased.

### [Manufacturing Method 4]

Although the additive element is added in one step in FIG. 1, FIG. 2, FIG. 3, FIG. 4, FIG. 5, and FIG. 6, the present invention is not limited to one step of adding, and the steps in FIG. 1, FIG. 2, FIG. 3, FIG. 4, FIG. 5, and FIG. 6 can be freely combined. Two steps of adding the additive element and three steps of adding the additive element are described with reference to FIG. 7 and FIG. 8, respectively.

In the method for manufacturing illustrated in FIG. 7, the composite hydroxide 98 containing the transition metal M and the additive element X1 is obtained first through steps similar to Step S11 to Step S33 in FIG. 1. Then, the additive element X3 source is mixed and the mixture is heated to obtain the positive electrode active material 100 through steps similar to Step S41 to Step S73 in FIG. 5.

In the method for manufacturing illustrated in FIG. 8, the composite hydroxide 98 containing the transition metal M and the additive element X1 is obtained through steps similar to Step S11 and Step S33 in FIG. 2. Then, the additive element X2 source is added to obtain the composite oxide 99 containing the transition metal M, the additive element X1, and the additive element X2 source through steps similar to Step S41 to Step S55 in FIG. 4. Furthermore, the positive electrode active material 100 is obtained through steps similar to Step S61 to Step S73 in FIG. 6.

Although not illustrated, the additive elements may be added through the two steps of adding the additive element X1 source and the additive element X2 source or the additive elements may be added through the two steps of adding the additive element X2 source and the additive element X3 source. Alternatively, the additive element may be added in a step other than the above steps.

When the steps of introducing a plurality of additive elements are separately performed in such a manner, the concentration profiles of the elements in the depth direction can vary in some cases. For example, the concentration of a certain additive element can be made higher in the superficial portion than in the inner portion of the positive electrode active material 100. Furthermore, the ratio of the number of atoms of a certain additive element to the number of atoms of the transition metal M can be made higher in the superficial portion than in the inner portion.

This embodiment can be implemented in combination with any of the other embodiments.

### Embodiment 2

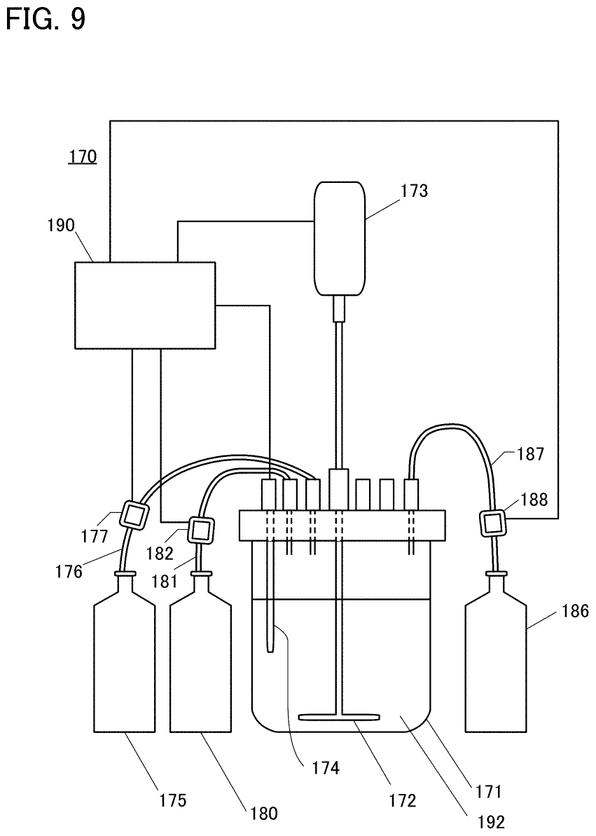

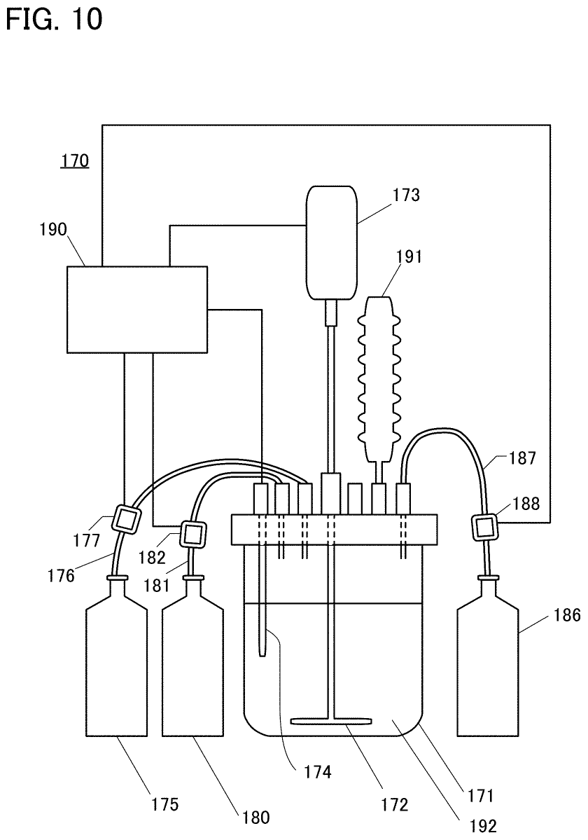

In this embodiment, a coprecipitation synthesis equipment that can be used for the manufacturing of the positive electrode active material described in Embodiment 1 is described with reference to FIG. 9 and FIG. 10.

A coprecipitation synthesis equipment 170 in FIG. 9 includes a reaction vessel 171, and the reaction vessel 171 includes a reaction container. A separable flask is used in the lower part of the reaction container and a separable cover is used in the upper part of the reaction container. The separable flask may be cylindrical or round type. A cylindrical separable flask has a flat bottom. The atmosphere of the reaction vessel 171 can be controlled with at least one inlet of the separable cover. For example, the atmosphere is preferably an inert atmosphere, preferably contains, e.g., nitrogen. In that case, nitrogen flow is preferably performed. In addition, nitrogen is preferably bubbled in water 192 put in the reaction vessel 171. The coprecipitation synthesis equipment 170 may be equipped with a reflux condenser 191 connected to at least one inlet of the separable cover as illustrated in FIG. 10, and the atmosphere gas such as nitrogen of the reaction vessel 171 is evacuated and water can return to the reaction vessel 171 with this reflux condenser 191. In the atmosphere of the reaction vessel 171, it is acceptable that the amount of streaming air necessary for evacuating a gas generated by a pyrolytic reaction due to heat treatment is maintained.

The water 192 is put in the reaction vessel 171, and then an acid solution and an alkali solution are dropped into the reaction vessel 171. Note that the water 192 put in the reaction vessel 171 is referred to as a filling liquid in some cases. The filling liquid is described as an adjustment liquid, and denotes an aqueous solution before a reaction, that is, an initial aqueous solution in some cases.

Another structure of the coprecipitation synthesis equipment 170 illustrated in FIG. 9 and FIG. 10 is described. The coprecipitation synthesis equipment 170 is equipped with a stirring portion 172, a stirring motor 173, a thermometer 174, a tank 175, a tube 176, a pump 177, a tank 180, a tube 181, a pump 182, a tank 186, a tube 187, a pump 188, a control device 190, and the like.

The stirring portion 172 can stir the water 192 in the reaction vessel 171, and the stirring motor 173 is provided as a power source for rotating the stirring portion 172. The stirring portion 172 includes a paddle-type impeller (referred to as paddle impeller) and the paddle impeller has two to six blades and each blade may have a gradient greater than or equal to 40° and less than or equal to 70°.

The thermometer 174 can measure the temperature of the water 192. The temperature of the reaction vessel 171 can be controlled with a heater, a thermoelectric cooling device, and the like so that the temperature of the water 192 can be kept constant. Examples of the thermoelectric cooling device include a Peltier device. A pH meter (not illustrated) is placed in the reaction vessel 171 to measure the pH of the water 192.

Different solutions of source materials can be pooled in the tanks. For example, the transition metal M source or an acid solution and an alkaline solution can fill the corresponding tanks. A tank filled with water serving as a filling liquid may be prepared. Each tank is equipped with a pump and an aqueous solution of a source material can be dropped into the reaction vessel 171 through a tube with use of the pump. The dropping amount of the aqueous solution of a source material, that is the amount of the delivered liquid, can be controlled with the pump. In addition, a valve is attached to the tube 176 in place of the pump, so that the dropping amount of the aqueous solution of a source material, that is the amount of the delivered liquid, can be controlled.

The control device 190 is electrically connected to the stirring motor 173, the thermometer 174, the pump 177, the pump 182, and the pump 188, whereby the rotation number of the stirring portion 172, the temperature of the water 192, the dropping amounts of the aqueous solutions of source materials, and the like can be controlled.

The rotation number of the stirring portion 172, specifically, the rotation number of the paddle impeller is preferably higher than or equal to 800 rpm and lower than or equal to 1200 rpm, for example. The stirring is preferably performed while the temperature of the water 192 is kept at higher than or equal to 50° C. and lower than or equal to 90° C. In the stirring, an acid solution or the like is preferably dropped into the reaction vessel 171 at a constant rate. Needless to say, the rotation number of the paddle impeller is not limited to a constant number, and can be appropriately adjusted. For example, the rotation number can be changed depending on the liquid amount of the reaction vessel 171. Moreover, the dropping rate of the acid solution or the like can be controlled. The dropping rate can be controlled to keep the pH of the reaction vessel 171 constant. Alternatively, the dropping rates can be controlled such that an alkaline solution is dropped when the pH varies from a desired value during the dropping of the acid solution or the like. The pH is within the range of 9.0 to 11.0, preferably 9.8 to 10.3.

Through the above process, a reaction product is precipitated in the reaction vessel 171. The reaction product contains the composite hydroxide 98. This reaction can be referred to as coprecipitation or co-precipitation, and this step is referred to as a coprecipitation step in some cases.

This embodiment can be implemented in combination with any of the other embodiments.

### Embodiment 3

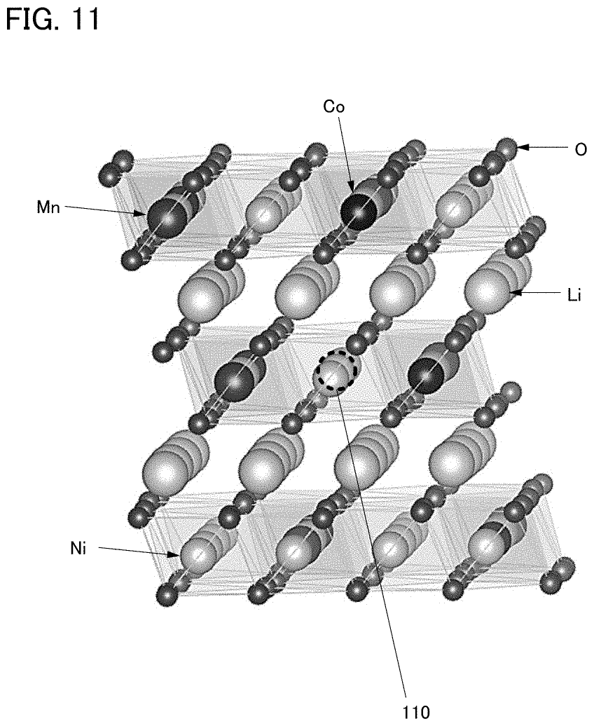

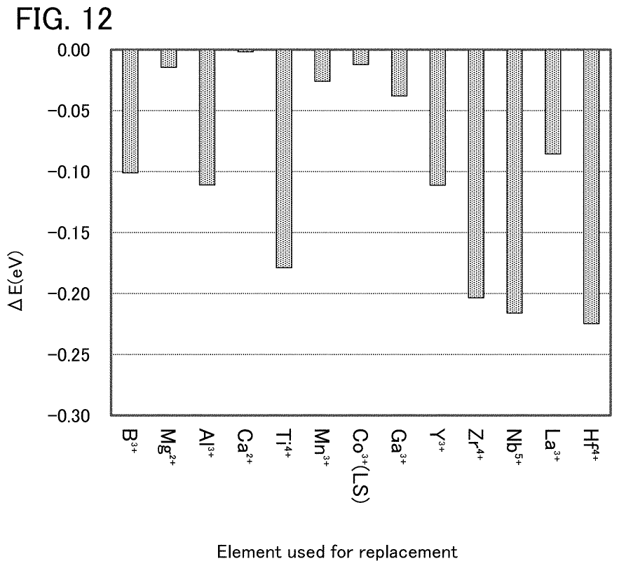

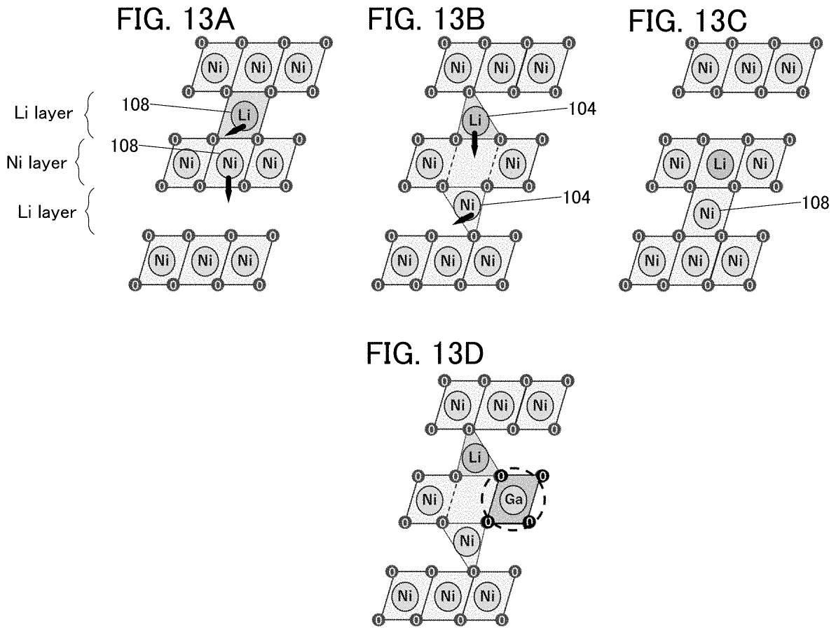

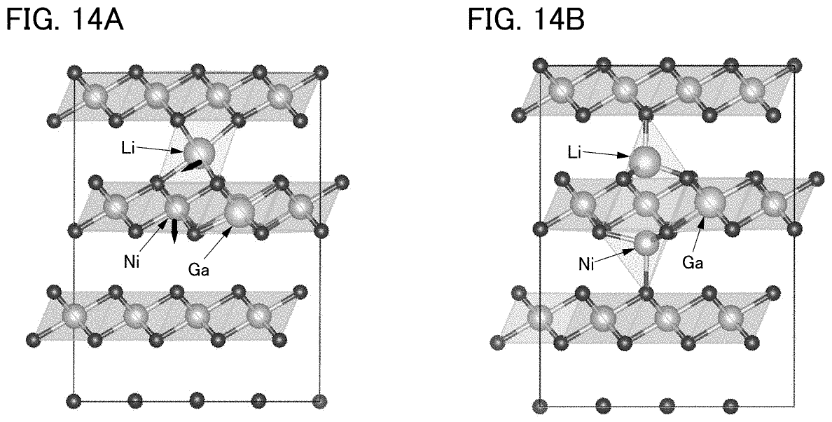

In this embodiment, the positive electrode active material 100 of one embodiment of the present invention will be described with reference to FIG. 11, FIG. 12, FIGS. 13A to 13D, and FIGS. 14A and 14B.

The positive electrode active material 100 includes a secondary particle in which primary particles are aggregated. The positive electrode active material 100 may have a space inside.

### <Contained Elements>

The positive electrode active material 100 contains lithium, the transition metal M, oxygen, and at least one of materials that can be used as the additive element X In this specification and the like, the additive element X collectively denotes the additive element X1, the additive element X2, and the additive element X3.

The positive electrode active material 100 can be regarded as a composite oxide represented by LiMO₂ to which the additive element X is added. Note that it is acceptable that the positive electrode active material of one embodiment of the present invention has a crystal structure of a lithium composite oxide represented by LiMO₂, and the composition is not strictly limited to Li:M:O=1:1:2.

The description in Embodiment 1 can be referred to for the transition metal M and the additive element X contained in the positive electrode active material 100, and a preferred proportion thereof

### <Element Distribution>

The additive element X in the positive electrode active material 100 preferably have a concentration gradient. In particular, the additive element X3 is added after the formation of the composite oxide 99; therefore, the additive element X3 tends to have a concentration gradient. For example, the positive electrode active material 100 preferably includes a superficial portion and an inner portion, and the concentration of the additive element X3 in the superficial portion is preferably higher than that in the inner portion.

Unlike the inner portion of a crystal, a particle surface is in a state where bonding is cut, and lithium is extracted from the surface during charging; thus, the lithium concentration in the surface tends to be lower than that in the inner portion. Therefore, the superficial portion tends to be unstable and its crystal structure is likely to be broken. Thus, the additive element X or a compound (e.g., an oxide of the additive element X) that is more chemically and structurally stable than a lithium composite oxide typified by LiMO₂ is contained in the superficial portion, whereby a change in the crystal structure can be effectively suppressed. In addition, a high concentration of the additive element X3 in the superficial portion probably increases the corrosion resistance to hydrofluoric acid generated by decomposition of the electrolyte solution.

If the superficial portion contains a compound of only the additive element X and oxygen, a lithium insertion/extraction path might be blocked. Thus, the superficial portion needs to contain at least the transition metal M, and also contain lithium in the discharged state to have the path through which lithium is inserted and extracted. Moreover, in the superficial portion, the concentration of the transition metal M is preferably higher than the concentration of the additive element X.

When the additive element X is distributed in the above manner, deterioration of the positive electrode active material 100 due to charge and discharge can be reduced. That is, deterioration of a secondary battery can be inhibited. Moreover, the secondary battery can be highly safe.

Note that the transition metal M, especially cobalt and nickel, is preferably dissolved uniformly in the entire positive electrode active material 100.

The positive electrode active material 100 of one embodiment of the present invention may be a positive electrode active material composite including a coating layer that covers at least part of the positive electrode active material 100. For example, at least one of glass, an oxide, and LiM2PO₄ (M2 is one or more of Fe, Ni, Co, and Mn), and the like can be used as the coating layer.

As a glass contained in the coating layer of the positive electrode active material composite, a material having an amorphous portion can be used. Examples of the material having an amorphous portion include a material including at least one of SiO₂, SiO, Al₂O₃, TiO₂, Li₄SiO₄, Li₃PO₄, Li₂S, SiS₂, B₂S₃, GeS₄, AgI, Ag₂O, Li₂O, P₂O₅, B₂O₃, V₂O₅, and the like; Li₇P₃S₁₁; and Li_{1+x+y}AlₓTi₂₋ₓSi_{y}P_{3-y}O₁₂ (0<x<2, 0<y<3). The material having an amorphous portion can be used in the state in which the whole part is amorphous or in the state of crystallized glass part of which is crystallized (also referred to as glass ceramic). The glass preferably has lithium-ion conductivity. Having the lithium-ion conductivity can also be regarded as having a diffusion property of lithium ions and a penetration property of lithium ions. The melting point of the glass is preferably 800° C. or lower, further preferably 500° C. or lower. Glass preferably has electron conductivity. Furthermore, glass preferably has a softening point of 800° C. or lower, for example, Li₂O—B₂O₃—SiO₂ based glass can be used.

Examples of the oxide contained in the coating layer of the positive electrode active material composite include aluminum oxide, zirconium oxide, hafnium oxide, and niobium oxide. Examples of LiM2PO₄ ((M2 is one or more of Fe, Ni, Co, and Mn) contained in the coating layer of the positive electrode active material composite include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≤1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≤1, 0<c<1, 0<d<1, and 0<e<1), and LiFe_{f}Ni_{g}CoₕMnᵢPO₄ (f+g+h+i≤1, 0<f<1, 0<g<1, 0<h<1, and 0<i<1).

Particle-composing process can be performed to form the coating layer of the positive electrode active material composite. Examples of the particle-composing process includes particle-composing process utilizing mechanical energy such as a mechanochemical process, a mechanofusion process, and a ball mill process; particle-composing process utilizing a liquid phase reaction such as a coprecipitation process, a hydrothermal process, and a sol-gel process; and particle-composing process utilizing a gas phase reaction such as a barrel sputtering process, an atomic layer deposition (ALD) process, an evaporation process, and a chemical vapor deposition (CVD) process. As the particle-composing process, at least any one of the above examples can be performed. For example, for the particle-composing process using mechanical energy, Picobond by Hosokawa Micron Ltd. can be used. Heat treatment is preferably performed once or more times in the particle-composing process.

### <Tendency of Additive Element X to Occupy a Nickel Site>

Below is described a calculation result regarding whether boron, magnesium, aluminum, calcium, titanium, gallium, yttrium, zirconium, niobium, lanthanum, and hafnium of the additive element X can exist stably at a nickel site of a layered rock-salt lithium composite oxide typified by LiMO₂. Results of cobalt and manganese are also shown for reference.

In this embodiment, LiMO₂ is evaluated in terms of stabilization energy as the whole. LiMO₂ contains nickel, cobalt, and manganese as the transition metal M where the proportion of nickel is the highest.

FIG. 11 shows a model used for the calculation. Energy change is calculated when nickel at a replacement site 110 illustrated in the middle of the model is replaced with another metal element. A metal element showing more stabilized energy can be regarded as an element that easily occupies the nickel site.

The calculation conditions are listed in Table 1.

TABLE 1

| Software | VASP |
|---|---|
| Functional | GGA + U (DFT-D2) |
| Pseudopotential | PAW |
| Cutoff energy (eV) | 600 |
| Atom number | 48 Li atoms, 35 Ni atoms, 6 Co atoms , 6 Mn |
| | atoms, 96 O atoms, 1 doping element |
| k-points | 1 × 1 × 1 |
| Calculation target | Optimization of lattice and atom position |

FIG. 12 shows the calculation results. LS in FIG. 12 means low spin. Energy is more stable when nickel is replaced with, for example, any one of boron, aluminum, titanium, gallium, yttrium, zirconium, niobium, lanthanum, and hafnium than when nickel is not replaced, or nickel is replaced with cobalt or manganese.

### <Suppression Effect of Surface Structure Change by Additive Element X>

Next, a calculating result of suppression of surface structure change when gallium, aluminum, magnesium, and calcium are used as the additive element X is described.

It is thought that in LiMO₂ with a high proportion of nickel, cation mixing, nickel occupying a lithium site, tends to occur due to repeated charge and discharge, and thus the surface structure changes into nickel oxide (NiO). Nickel oxide is inert to a battery reaction. Therefore, it is important to suppress the change of the surface structure of LiMO₂ into NiO in order to suppress the deterioration.

In this embodiment, calculation is started from an initial model that is a state before nickel moves to the lithium site (before replacement). A LiNiO₂ model, in which LiMO₂ has a large amount of nickel, is the initial state. The initial state is illustrated in FIG. 13A in which all octahedron sites 108 are occupied by lithium and nickel.

Following the initial state, a structure where nickel has moved to a tetrahedron site 104 in the lithium layer is an intermediate state. The intermediate state is illustrated in FIG. 13B.

A structure in which the octahedron site 108 is occupied by the nickel is a final state. The final state is illustrated in FIG. 13C.

Note that the tetrahedron site 104 contains four ion-bonded oxygen atoms and the octahedron site 108 contains six ion-bonded oxygen atoms.

In this embodiment, how difficult it is to cause the structure change from the initial state to the intermediate state when a nickel site is replaced with the additive element X is evaluated. FIG. 13D illustrates an example in which a nickel site shown by the broken line is replaced with gallium.

The calculation conditions are shown in Table 2. FIGS. 14A and 14B illustrate calculation results of the initial state and the intermediate state, respectively, in the case where the additive element X is gallium.

TABLE 2

| Software | VASP |
|---|---|
| Functional | GGA + U (DFT-D2) |
| Pseudopotential | PAW |
| Cutoff energy (eV) | 600 |
| Potential U | Ni 5.26 |
| Atom number | 1 Li atom, 47 Ni atoms, 96 O atoms, 1 |
| | doping element |
| k-points | 1 × 1 × 1 |
| Calculation target | Optimization of lattice and atom position |

In the initial state in FIG. 14A and the intermediate state in FIG. 14B, a large distortion is not seen around gallium occupying the nickel site, which demonstrates that gallium can occupy the nickel site stably.

Table 3 shows comparison results of energy difference between the initial state and the intermediate state with/without the additive element X

TABLE 3

| | Ni | | | | |
|---|---|---|---|---|---|
| | (Not replaced) | Ca | Ga | Al | Mg |
| Formation energy | 1.20 | 1.65 | 1.88 | 1.91 | 1.92 |
| [eV] of tetrahedron | | | | | |

As is seen from Table 3, it is found that the replacement between nickel and lithium hardly occurs in the case of containing the additive element X such as calcium, gallium, aluminum, and magnesium, as compared with the case where nickel is not replaced. This effect is more distinctive in the case of using gallium, aluminum, and magnesium.

The above results suggest that the cation mixing is suppressed when gallium, aluminum, or magnesium is contained as the additive element X, which indicates the possibility that the deterioration of the positive electrode active material 100 is suppressed and the capacity retention rate is improved.

This embodiment can be implemented in combination with any of the other embodiments.

### Embodiment 4

This embodiment will describe examples of shapes of several types of secondary batteries including a positive electrode active material formed by the manufacturing method described in the foregoing embodiment.

### [Coin-Type Secondary Battery]

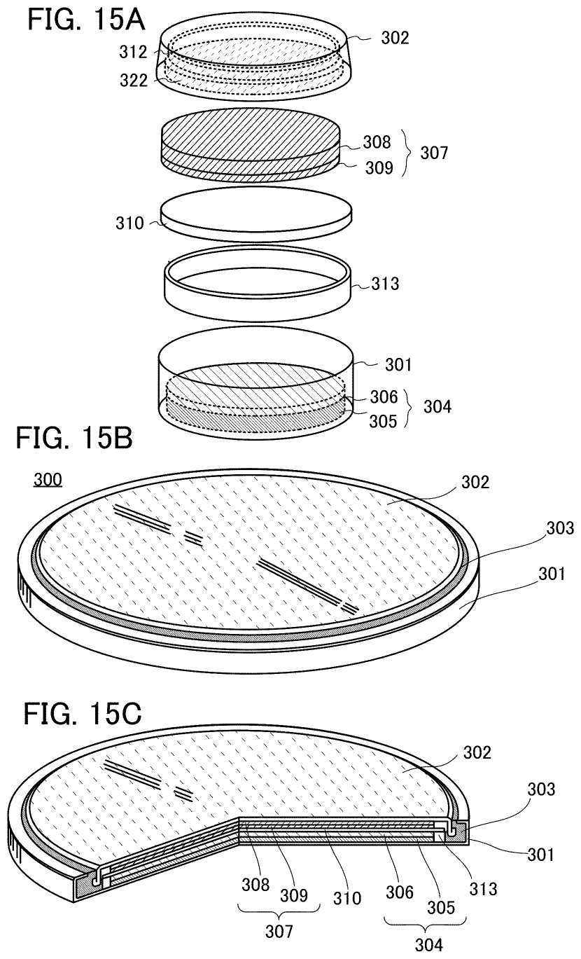

An example of a coin-type secondary battery is described. FIG. 15A, FIG. 15B, and FIG. 15C are an exploded perspective view, an external view, and a cross-sectional view of a coin-type (single-layer flat) secondary battery. Coin-type secondary batteries are mainly used in small electronic devices. In this specification and the like, coin-type batteries include button-type batteries.

For easy understanding, FIG. 15A is a schematic view showing overlap (a vertical relation and a positional relation) between components. Thus, FIG. 15A and FIG. 15B do not completely correspond with each other.

In FIG. 15A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 15A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 is a stack in which a positive electrode active material layer 306 is formed over a positive electrode current collector 305.

To prevent a short circuit between the positive electrode and the negative electrode, the separator 310 and a ring-shaped insulator 313 are provided to cover the side surface and top surface of the positive electrode 304. The separator 310 has a larger flat surface area than the positive electrode 304.

FIG. 15B is a perspective view of a completed coin-type secondary battery.

In a coin-type secondary battery 300, a positive electrode can 301 doubling as a positive electrode terminal and a negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 15C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is manufactured.

With the above structure, the coin-type secondary battery 300 can have high capacity, high charge and discharge capacity, and excellent cycle performance. In addition, in the case where a secondary battery including a solid electrolyte layer is provided between the negative electrode 307 and the positive electrode 304, the separator 310 can be unnecessary.

### [Cylindrical Secondary Battery]

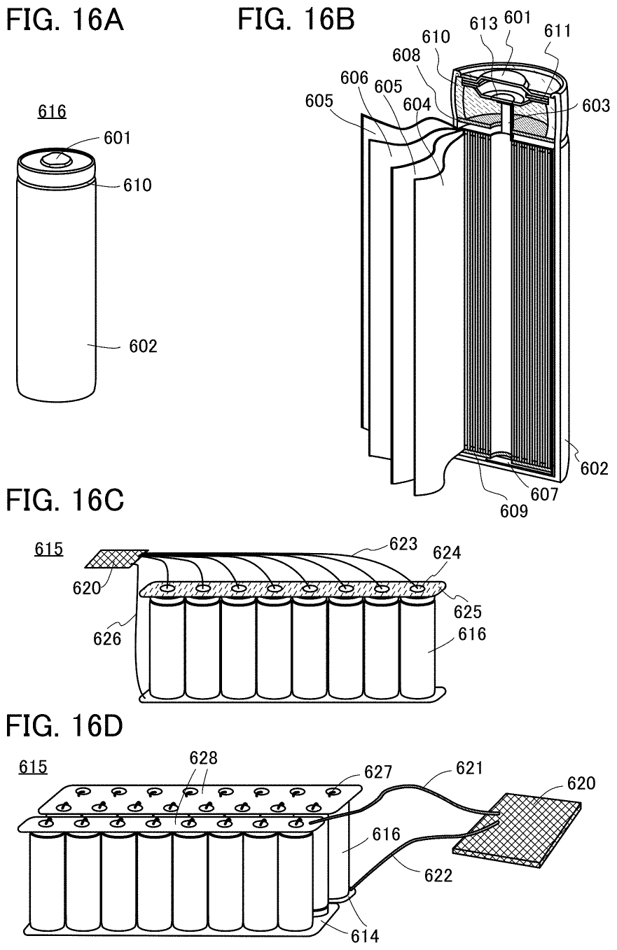

An example of a cylindrical secondary battery is described with reference to FIG. 16A. As illustrated in FIG. 16A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 16B is a schematic view of a cross-section of the cylindrical secondary battery. The cylindrical secondary battery illustrated in FIG. 16B includes the positive electrode cap (battery cap) 601 on the top surface and the battery can (outer can) 602 on the side and bottom surfaces. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like separator 605 located therebetween is provided. Although not illustrated, the battery element is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, the inside of the battery can 602 provided with the battery element is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors. Although FIGS. 16A to 16D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 100 obtained in the foregoing embodiment is used in the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold value. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 16C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used, for example.

FIG. 16D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 16D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### [Other Structure Examples of Secondary Battery]

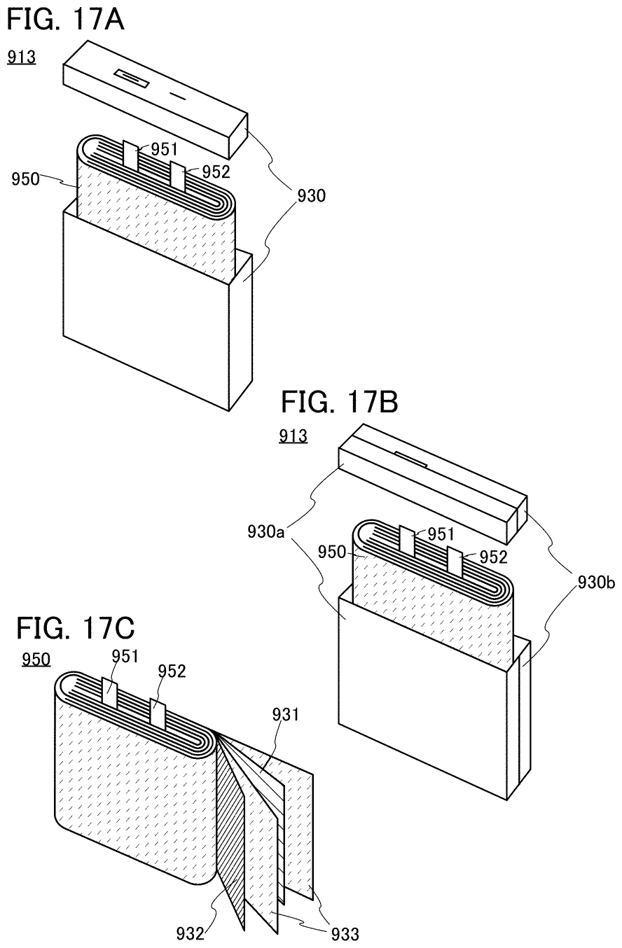

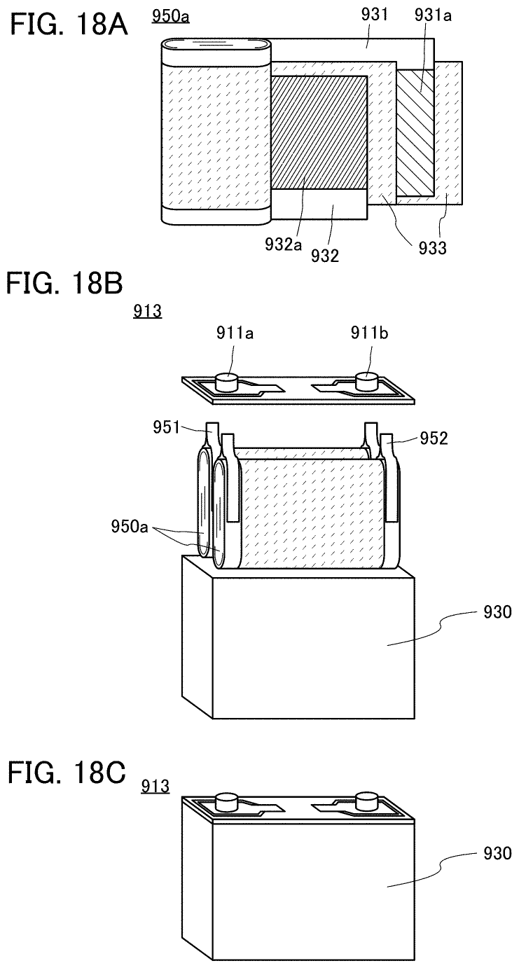

Structure examples of secondary batteries are described with reference to FIGS. 17A to 17C and FIGS. 18A to 18C.

A secondary battery 913 illustrated in FIG. 17A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that FIG. 17A illustrates the housing 930 divided into two pieces for convenience; however, in the actual structure, the wound body 950 is covered with the housing 930 and the terminals 951 and 952 extend to the outside of the housing 930. For the housing 930, a metal material (e.g., aluminum) or a resin material can be used.

Note that as illustrated in FIG. 17B, the housing 930 in FIG. 17A may be formed using a plurality of materials. For example, in the secondary battery 913 in FIG. 17B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 17C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with the separator 933 therebetween. Additionally, a plurality of stacks each including the negative electrode 931, the positive electrode 932, and the separators 933 may be overlaid.

As illustrated in FIGS. 18A to 18C, the secondary battery 913 may include a wound body 950a. The wound body 950a illustrated in FIG. 18A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in the foregoing embodiment is used in the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 18B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 18C, the wound body 950a and an electrolyte solution are covered with the housing 930, whereby the secondary battery 913 is obtained. The housing 930 is preferably provided with a safety valve, an overcurrent protection element, and the like. A safety valve is a valve to be released by a predetermined internal pressure of the housing 930 in order to prevent the battery from exploding.

As illustrated in FIG. 18B, the secondary battery 913 may include a plurality of wound bodies 950a. The use of the plurality of wound bodies 950a enables the secondary battery 913 to have higher charge and discharge capacity. The description of the secondary battery 913 in FIGS. 17A to 17C can be referred to for the other components of the secondary battery 913 in FIGS. 18A and 18B.

### <Laminated Secondary Battery>

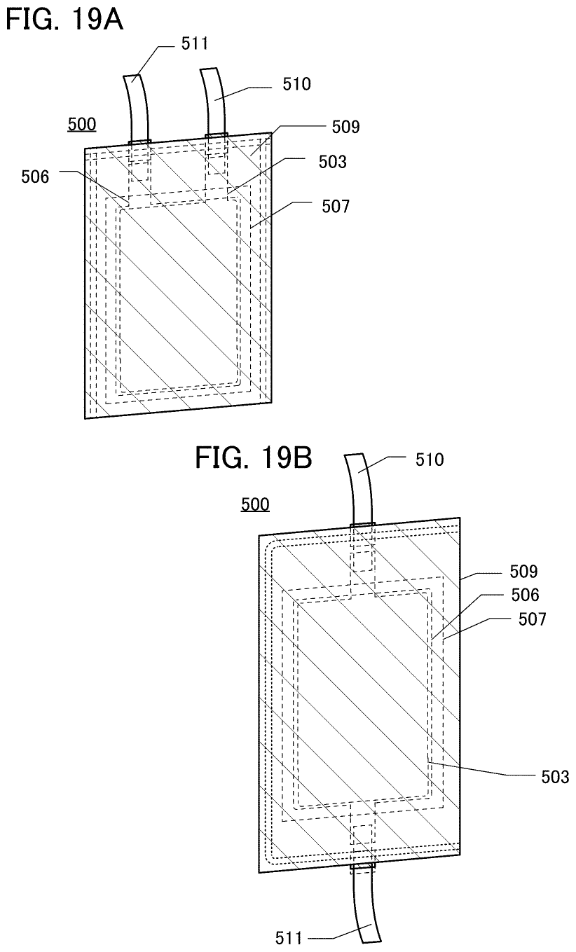

Next, examples of the appearance of a laminated secondary battery are shown in FIGS. 19A and 19B. FIGS. 19A and 19B each illustrate a positive electrode 503, a negative electrode 506, a separator 507, an exterior body 509, a positive electrode lead electrode 510, and a negative electrode lead electrode 511.

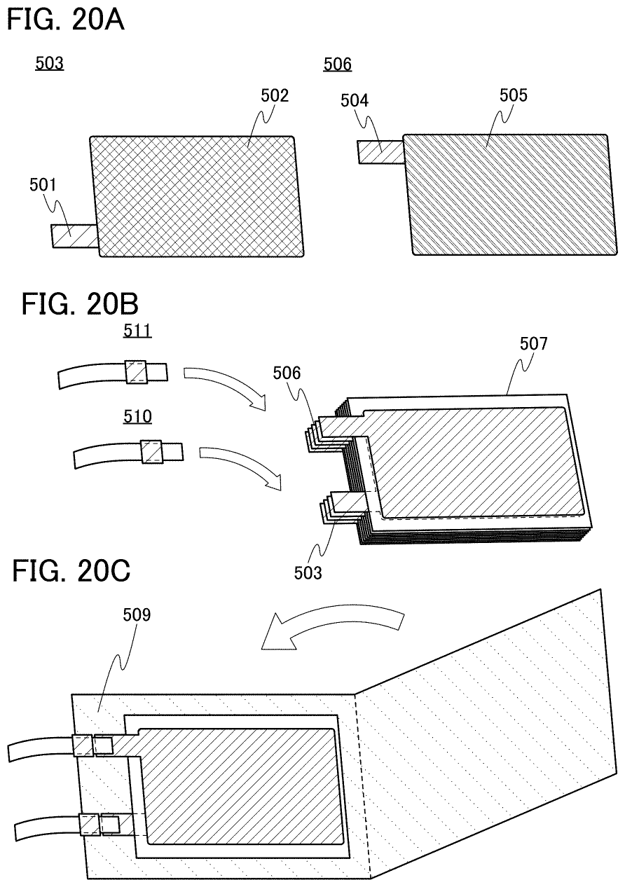

FIG. 20A illustrates external views of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas and the shapes of the tab regions included in the positive electrode and the negative electrode are not limited to those in the example illustrated in FIG. 20A.

### <Method for Manufacturing Laminated Secondary Battery>

Here, an example of a method for manufacturing the laminated secondary battery having the appearance illustrated in FIG. 19A will be described with reference to FIGS. 20B and 20C.

First, the negative electrode 506, the separator 507, and the positive electrode 503 are stacked. FIG. 20B illustrates a stack including the negative electrode 506, the separator 507, and the positive electrode 503. The secondary battery in this example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 20C. Then, the outer edges of the exterior body 509 are bonded to each other. The bonding can be performed by thermocompression, for example. At this time, a part (or one side) of the exterior body 509 is left unbonded (to provide an inlet) so that the electrolyte solution 508 can be introduced later.

Next, the electrolyte solution 508 (not illustrated) is introduced into the exterior body 509 from the inlet of the exterior body 509. The electrolyte solution 508 is preferably introduced in a reduced pressure atmosphere or in an inert atmosphere. Lastly, the inlet is sealed by bonding. In this manner, the laminated secondary battery 500 can be fabricated.

The positive electrode active material 100 obtained in the foregoing embodiment is used in the positive electrodes 503, whereby the secondary battery 500 can have high capacity, high charge and discharge capacity, and excellent cycle performance.

### [Examples of Battery Pack]

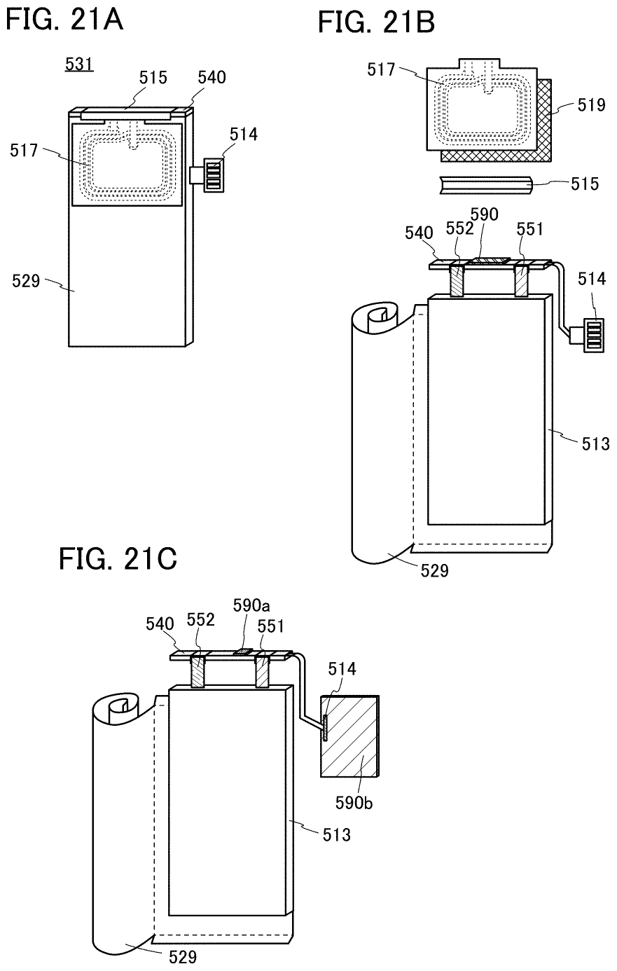

Examples of a secondary battery pack of one embodiment of the present invention that is capable of wireless charging using an antenna will be described with reference to FIGS. 21A to 21C.

FIG. 21A illustrates the appearance of a secondary battery pack 531 that has a rectangular solid shape with a small thickness (also referred to as a flat plate shape with a certain thickness). FIG. 21B illustrates the structure of the secondary battery pack 531. The secondary battery pack 531 includes a circuit board 540 and a secondary battery 513. A label 529 is attached to the secondary battery 513. The circuit board 540 is fixed by a sealant 515. The secondary battery pack 531 also includes an antenna 517.

As for the internal structure of the secondary battery 513, the secondary battery 513 may include a wound body or a stack.

In the secondary battery pack 531, a control circuit 590 is provided over the circuit board 540 as illustrated in FIG. 21B, for example. The circuit board 540 is electrically connected to a terminal 514. Moreover, the circuit board 540 is electrically connected to the antenna 517 and a positive electrode lead and a negative electrode lead 551 and 552 of the secondary battery 513.

Alternatively, as illustrated in FIG. 21C, a circuit system 590a provided over the circuit board 540 and a circuit system 590b electrically connected to the circuit board 540 through the terminal 514 may be included.

Note that the shape of the antenna 517 is not limited to a coil shape and may be a linear shape or a plate shape, for example. Furthermore, a planar antenna, an aperture antenna, a traveling-wave antenna, an EH antenna, a magnetic-field antenna, a dielectric antenna, or the like may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

The secondary battery pack 531 includes a layer 519 between the antenna 517 and the secondary battery 513. The layer 519 has a function of blocking an electromagnetic field from the secondary battery 513, for example. As the layer 519, a magnetic material can be used, for example.

### [Positive Electrode]

The positive electrode includes a positive electrode active material layer and a positive electrode current collector. The positive electrode active material layer includes a positive electrode active material, and may include a conductive material and a binder. As the positive electrode active material, the positive electrode active material formed by any of the manufacturing methods described in the foregoing embodiment is used.

The positive electrode active material described in the foregoing embodiment and another positive electrode active material may be mixed to be used.

Other examples of the positive electrode active material include a composite oxide with an olivine crystal structure, a composite oxide with a layered rock-salt crystal structure, and a composite oxide with a spinel crystal structure. For example, a compound such as LiFePO₄, LiFeO₂, LiNiO₂, LiMn₂O₄, V₂O₅, Cr₂O₅, or MnO₂ can be used.

As another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

Another example of the positive electrode active material is a lithium-manganese composite oxide that can be represented by a composition formula LiₐMn_{b}M_{c}O_{d}. Here, the element M is preferably silicon, phosphorus, or a metal element other than lithium and manganese, further preferably nickel. In the case where the whole particles of a lithium-manganese composite oxide is measured, it is preferable to satisfy the following at the time of discharge: 0<a/(b+c)<2; c>0; and 0.26 (b+c)/d<0.5. Note that the proportions of metals, silicon, phosphorus, and other elements in the whole particles of a lithium-manganese composite oxide can be measured with, for example, an inductively coupled plasma mass spectrometer (ICP-MS). The proportion of oxygen in the whole particles of a lithium-manganese composite oxide can be measured by, for example, energy dispersive X-ray spectroscopy (EDX). Alternatively, the proportion of oxygen can be measured by ICP-MS combined with fusion gas analysis and valence evaluation of X-ray absorption fine structure (XAFS) analysis. Note that the lithium-manganese composite oxide is an oxide containing at least lithium and manganese, and may contain at least one selected from chromium, cobalt, aluminum, nickel, iron, magnesium, molybdenum, zinc, indium, gallium, copper, titanium, niobium, silicon, phosphorus, and the like.

### <Conductive Material>

A conductive material is also referred to as a conductivity-imparting agent and a conductive additive, and a carbon material is used as the conductive material. A conductive additive is attached between a plurality of active materials, whereby the plurality of active materials are electrically connected to each other, and the conductivity increases. Note that the term “attach” refers not only to a state where an active material and a conductive additive are physically in close contact with each other, and includes, for example, the following concepts: the case covalent bonding occurs, the case where bonding with the Van der Waals force occurs, the case where a conductive additive covers part of the surface of an active material, the case where a conductive additive is embedded in surface roughness of an active material, and the case where an active material and a conductive material are electrically connected to each other without being in contact with each other.

Typical examples of the carbon material used as the conductive material include carbon black (e.g., furnace black, acetylene black, and graphite).

In particular, graphene or a graphene compound is preferably used as the conductive material.

A graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of six-membered rings of carbon atoms. The two-dimensional structure formed of the six-membered ring composed of carbon atoms may be referred to as a carbon sheet. A graphene compound may include a functional group. The graphene compound is preferably bent. A graphene compound may be rounded like a carbon nanofiber.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. A graphene compound may also be referred to as a carbon sheet. The reduced graphene oxide functions by itself and may have a stacked-layer structure. The reduced graphene oxide preferably includes a portion where the carbon concentration is higher than 80 at % and the oxygen concentration is higher than or equal to 2 at % and lower than or equal to 15 at %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount.

The graphene and graphene compound may have excellent electrical characteristics of high conductivity and excellent physical properties of high flexibility and high mechanical strength. The graphene and graphene compound have a sheet-like shape. The graphene and graphene compound sometimes have a curved surface, thereby enabling low-resistant surface contact. Furthermore, the graphene and graphene compound sometimes have extremely high conductivity even with a small thickness, in which case a conductive path can be efficiently formed in an active material layer with a small amount of the graphene and graphene compound. Hence, the use of the graphene or graphene compound as the conductive material can increase the area where the active material and the conductive material are in contact with each other. The graphene or graphene compound preferably covers 80% or more of the area of the active material. Note that the graphene or graphene compound preferably clings to at least part of an active material particle. The graphene or a graphene compound preferably overlays at least part of the active material particle. The shape of the graphene or graphene compound preferably conforms to at least part of the shape of the active material particle. The shape of an active material particle means, for example, unevenness of a single active material particle or unevenness formed by a plurality of active material particles. The graphene or graphene compound preferably surrounds at least part of an active material particle. The graphene or graphene compound may have a hole.

In the case where active material particles with a small diameter (e.g., 1 μm or less) are used, the specific surface area of the active material particles is large and thus more conductive paths for the active material particles are needed. In such a case, it is particularly preferred that graphene or a graphene compound that can efficiently form a conductive path even with a small amount be used.

It is particularly effective to use a graphene compound, which has the above-described properties, as a conductive material of a secondary battery that needs to be rapidly charged and discharged. For example, a secondary battery for a two- or four-wheeled vehicle, a secondary battery for a drone, or the like is required to have fast charge and discharge characteristics in some cases. In addition, a mobile electronic device or the like is required to have fast charge characteristics in some cases. In addition, a mobile electronic device or the like is required to have fast charge characteristics in some cases. Fast charge and discharge may also be referred to as charge and discharge at a high rate, for example, at 1 C, 2 C, or 5 C or more.

A material used in formation of graphene or the graphene compound may be mixed with graphene or the graphene compound to be used for an active material layer 200. For example, particles used as a catalyst in formation of graphene or the graphene compound may be mixed with graphene or the graphene compound. As an example of the catalyst in formation of graphene or the graphene compound, particles containing any of silicon oxide (SiO₂ or SiOₓ (x<2)), aluminum oxide, iron, nickel, ruthenium, iridium, platinum, copper, germanium, and the like can be given. The median diameter (D50) of the particles is preferably less than or equal to 1 μm, further preferably less than or equal to 100 nm.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide can be used, for example. Examples of the polysaccharide include cellulose derivatives such as carboxymethyl cellulose (CMC), methyl cellulose, ethyl cellulose, hydroxypropyl cellulose, diacetyl cellulose, and regenerated cellulose and starch. It is further preferable that such water-soluble polymers be used in combination with any of the above rubber materials.

Alternatively, as the binder, a material such as polystyrene, poly(methyl acrylate), poly(methyl methacrylate) (PNMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As such a material having a significant viscosity modifying effect, for instance, a water-soluble polymer is preferably used. Example of the water-soluble polymer having a significant viscosity modifying effect include the above-mentioned polysaccharides such as a cellulose derivative such as carboxymethyl cellulose (CMC), methyl cellulose, ethyl cellulose, hydroxypropyl cellulose, diacetyl cellulose, and regenerated cellulose, and starch.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### <Positive Electrode Current Collector>

The positive electrode current collector can be formed using a material that has high conductivity, such as a metal like stainless steel, gold, platinum, aluminum, or titanium, or an alloy thereof. It is preferred that a material used for the positive electrode current collector not be eluted at the potential of the positive electrode. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The positive electrode current collector can have a foil-like shape, a plate-like shape, a sheet-like shape, a net-like shape, a punching-metal shape, an expanded-metal shape, or the like as appropriate. The positive electrode current collector preferably has a thickness greater than or equal to 5 μm and less than or equal to 30 μm.

### [Negative Electrode]

The negative electrode includes a negative electrode active material layer and a negative electrode current collector. The negative electrode active material layer may contain a conductive material and a binder.

As the negative electrode active material, an alloy-based material, a carbon-based material, or a mixture thereof can be used, for example.

As the negative electrode active material, an element that enables charge and discharge reactions by alloying and dealloying reactions with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium, a compound containing the element, and the like may be referred to as an alloy-based material.

In this specification and the like, SiO refers to silicon monoxide, for example. Alternative, SiO can be expressed as SiOₓ. Here, it is preferable that x be 1 or have an approximate value of 1. For example, x is preferably 0.2 or more and 1.5 or less, further preferably 0.3 or more and 1.2 or less.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it has a spherical shape in some cases. Moreover, in some cases, MCMB is preferably used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li+) when lithium ions are intercalated into the graphite (while a lithium-graphite intercalation compound is generated). For this reason, a lithium-ion secondary battery using graphite can have a high operating voltage. In addition, graphite is preferable because of its advantages such as a relatively high capacity per unit volume, relatively small volume expansion, low cost, and higher level of safety than that of a lithium metal.

As the negative electrode active material, an oxide such as titanium dioxide (TiO₂), lithium titanate (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M is Co, Ni, or Cu) with a Li₃N structure, which is a nitride containing lithium and a transition metal, can be used. For example, Li_{2.6}Co_{0.4}N₃ is preferable because of its high charge and discharge capacity (900 mAh/g and 1890 mAh/cm³).

A nitride containing lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), and iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those of the conductive material and the binder that can be included in the positive electrode active material layer can be used.

For the negative electrode current collector, copper or the like can be used in addition to a material similar to that for the positive electrode current collector. Note that a material that is not alloyed with carrier ions of lithium or the like is preferably used for the negative electrode current collector.

### [Electrolyte Solution]

As one mode of the electrolyte, an electrolyte solution containing a solvent and an electrolyte dissolved in the solvent can be used. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more kinds of ionic liquids (room temperature molten salts) which have features of non-flammability and non-volatility as the solvent of the electrolyte solution can prevent a power storage device from exploding and catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (LiB(C₂O₄)₂, LiBOB) can be used, or two or more of these lithium salts can be used in an appropriate combination in an appropriate ratio.

The electrolyte solution used for the power storage device is preferably a highly-purified electrolyte solution with only a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

Furthermore, an additive agent such as vinylene carbonate, propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent where an electrolyte is dissolved, is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, the secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO), PVDF, polyacrylonitrile, or a copolymer containing any of them can be used. For example, PVDF-HFP, which is a copolymer of PVDF and hexafluoropropylene (HFP), can be used. The formed polymer may be porous.

### [Separator]

The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Although a material in a glass state can be used as a ceramic material, the material preferably has a low electron conductivity, unlike the glass used for an electrode. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging and discharging at high voltage can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

The contents in this embodiment can be freely combined with any of the contents in the other embodiments.

### Embodiment 5

This embodiment will describe an example where an all-solid-state battery is manufactured using the positive electrode active material 100 obtained in the foregoing embodiment.

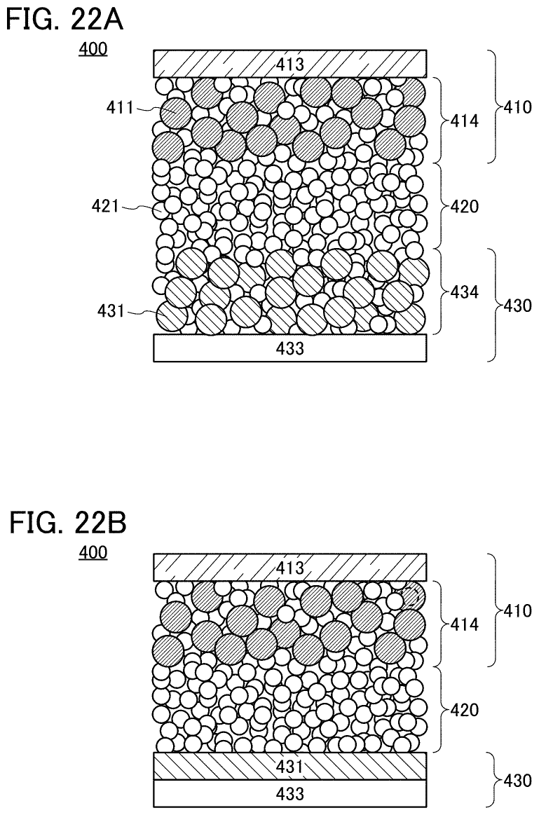

As illustrated in FIG. 22A, a secondary battery 400 of one embodiment of the present invention includes a positive electrode 410, a solid electrolyte layer 420, and a negative electrode 430.

The positive electrode 410 includes a positive electrode current collector 413 and a positive electrode active material layer 414. The positive electrode active material layer 414 includes a positive electrode active material 411 and a solid electrolyte 421. The positive electrode active material 100 obtained in the foregoing embodiment is used as the positive electrode active material 411. The positive electrode active material layer 414 may also include a conductive material and a binder.

The solid electrolyte layer 420 includes the solid electrolyte 421. The solid electrolyte layer 420 is positioned between the positive electrode 410 and the negative electrode 430 and is a region that includes neither the positive electrode active material 411 nor a negative electrode active material 431.

The negative electrode 430 includes a negative electrode current collector 433 and a negative electrode active material layer 434. The negative electrode active material layer 434 includes the negative electrode active material 431 and the solid electrolyte 421. The negative electrode active material layer 434 may also include a conductive material and a binder. Note that when metal lithium is used as the negative electrode active material 431, metal lithium does not need to be processed into particles; thus, the negative electrode 430 that does not include the solid electrolyte 421 can be formed, as illustrated in FIG. 22B. The use of metal lithium for the negative electrode 430 is preferable, in which case the energy density of the secondary battery 400 can be increased.

As the solid electrolyte 421 included in the solid electrolyte layer 420, a sulfide-based solid electrolyte, an oxide-based solid electrolyte, or a halide-based solid electrolyte can be used, for example.

Examples of the sulfide-based solid electrolyte include a thio-LISICON-based material (e.g., Li₁₀GeP₂S₁₂ and Li_{3.25}Ge_{0.25}P_{0.75}S₄), sulfide glass (e.g., 70Li₂S.30P₂S₅, 30Li₂S.26B₂S₃.44LiI, 63Li₂S.36SiS₂.1Li₃PO₄, 57Li₂S.38SiS₂.5Li₄SiO₄, and 50Li₂S.50GeS₂), and sulfide-based crystallized glass (e.g., Li₇P₃S₁₁ and Li_{3.25}P_{0.95}S₄). The sulfide-based solid electrolyte has advantages such as high conductivity, low-temperature synthesis, and ease of maintaining a path for electrical conduction after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li_{1-y}Al_{y}Ti_{2-y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄.50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can also be used as the solid electrolyte.

Alternatively, different solid electrolytes may be mixed and used.

In particular, Li₁₊ₓAlₓTi₂₋ₓ(PO₄)₃ (0<x<1) having a NASICON crystal structure (hereinafter, LATP) is preferable because LATP contains aluminum and titanium, each of which is the element the positive electrode active material used in the secondary battery 400 of one embodiment of the present invention is allowed to contain, and thus a synergistic effect of improving the cycle performance is expected. Moreover, higher productivity due to the reduction in the number of steps is expected. Note that in this specification and the like, a material having a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

### <Exterior Body and Shape of Secondary Battery>

An exterior body of the secondary battery 400 of one embodiment of the present invention can employ a variety of materials and have a variety of shapes, and preferably has a function of applying pressure to the positive electrode, the solid electrolyte layer, and the negative electrode.

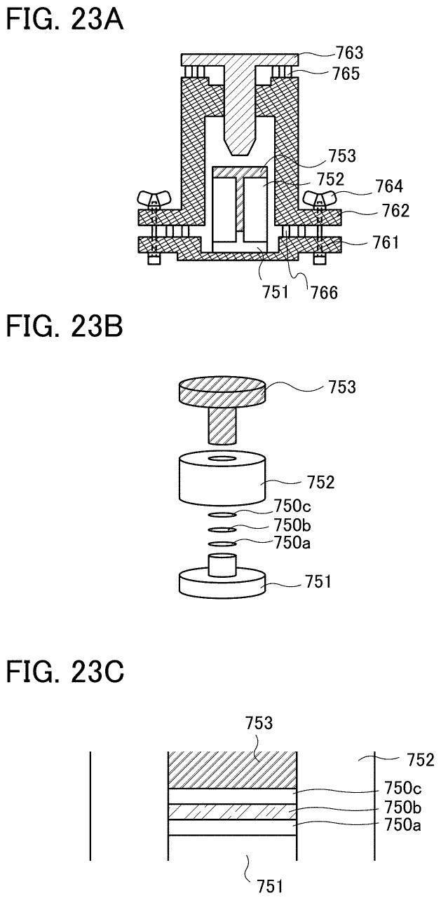

FIGS. 23A to 23C illustrate an example of a cell for evaluating materials of an all-solid-state battery.

FIG. 23A is a schematic cross-sectional view of the evaluation cell. The evaluation cell includes a lower component 761, an upper component 762, and a fixation screw/butterfly nut 764 for fixing these components. By rotating a pressure screw 763, an electrode plate 753 is pressed to fix an evaluation material. An insulator 766 is provided between the lower component 761 and the upper component 762 that are made of a stainless steel material. An 0 ring 765 for hermetic sealing is provided between the upper component 762 and the pressure screw 763.

The evaluation material is placed on an electrode plate 751, surrounded by an insulating tube 752, and pressed from above by the electrode plate 753. FIG. 23B is an enlarged perspective view of the evaluation material and its vicinity.

A stack of a positive electrode 750a, a solid electrolyte layer 750b, and a negative electrode 750c is illustrated as an example of the evaluation material, and its cross section is shown in FIG. 23C. Note that the same portions in FIGS. 23A to 23C are denoted by the same reference numerals.

The electrode plate 751 and the lower component 761 that are electrically connected to the positive electrode 750a correspond to a positive electrode terminal. The electrode plate 753 and the upper component 762 that are electrically connected to the negative electrode 750c correspond to a negative electrode terminal. The electric resistance or the like can be measured while pressure is applied to the evaluation material through the electrode plate 751 and the electrode plate 753.

The exterior body of the secondary battery of one embodiment of the present invention is preferably a package having excellent airtightness. For example, a ceramic package or a resin package can be used. The exterior body is sealed preferably in a closed atmosphere where the outside air is blocked, for example, in a glove box.

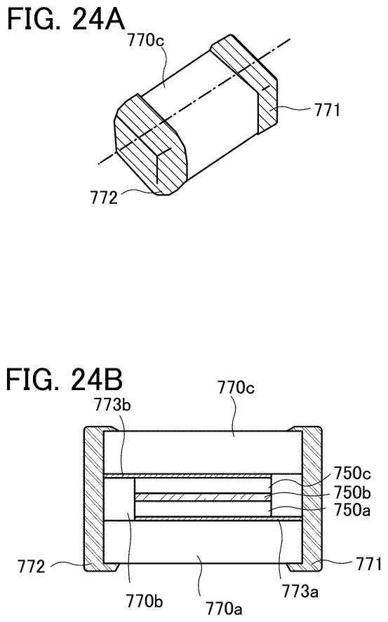

FIG. 24A is a perspective view of a secondary battery of one embodiment of the present invention that has an exterior body and a shape different from those in FIGS. 23A to 23C. The secondary battery in FIG. 24A includes external electrodes 771 and 772 and is sealed with an exterior body including a plurality of package components.

FIG. 24B illustrates an example of a cross section along the dashed-dotted line in FIG. 24A. A stack including the positive electrode 750a, the solid electrolyte layer 750b, and the negative electrode 750c is surrounded and sealed by a package component 770a including an electrode layer 773a on a flat plate, a frame-like package component 770b, and a package component 770c including an electrode layer 773b on a flat plate.

For the package components 770a, 770b, and 770c, insulating materials such as a resin material or ceramic can be used.

The external electrode 771 is electrically connected to the positive electrode 750a through the electrode layer 773a and functions as a positive electrode terminal. The external electrode 772 is electrically connected to the negative electrode 750c through the electrode layer 773b and functions as a negative electrode terminal.

The use of the positive electrode active material 100 obtained in the foregoing embodiment achieves an all-solid-state secondary battery having a high energy density and favorable output characteristics.

The contents in this embodiment can be combined with any of the contents in the other embodiments as appropriate.

### Embodiment 6

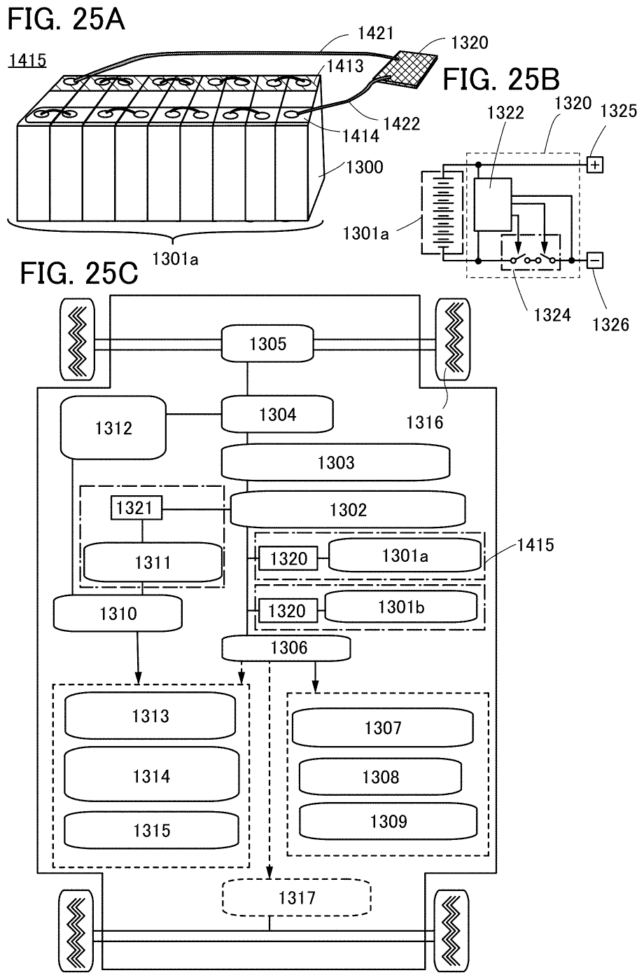

This embodiment will describe an example of a secondary battery different from the cylindrical secondary battery illustrated in FIG. 16D. An application example of the secondary battery in an electric vehicle (EV) will be described with reference to FIG. 25C.

The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 specifically needs high output and does not necessarily have high capacity, and the capacity of the second battery 1311 is lower than that of the first batteries 1301a and 1301b.

The internal structure of the first battery 1301a may be the wound structure illustrated in FIG. 17A or FIG. 18C or the stacked structure illustrated in FIG. 19A or FIG. 19B. Alternatively, the first battery 1301a may be the all-solid-state battery in Embodiment 4. Using the all-solid-state battery in Embodiment 4 as the first battery 1301a achieves high capacity, a high degree of safety, and reduction in size and weight.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is also used to rotate the rear motor 1317.

The second battery 1311 supplies electric power to in-vehicle parts for 14V (such as an audio 1313, power windows 1314, and lamps 1315) through a DC-DC circuit 1310.

The first battery 1301a is described with reference to FIG. 25A.

FIG. 25A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows the example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a battery operating system or a battery oxide semiconductor (BTOS).

A metal oxide functioning as an oxide semiconductor is preferably used. For example, as the oxide, a metal oxide such as an In-M-Zn oxide (the element M is one or more of aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is used. In particular, the In-M-Zn oxide that can be used as the oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. In addition, the CAC-OS has, for example, a composition in which elements included in a metal oxide are unevenly distributed. Materials including unevenly distributed elements each have a size greater than or equal to 0.5 nm and less than or equal to 10 nm, preferably greater than or equal to 1 nm and less than or equal to 3 nm, or a similar size. Note that in the following description of a metal oxide, a state in which one or more types of metal elements are unevenly distributed and regions including the metal element(s) are mixed is referred to as a mosaic pattern or a patch-like pattern. The regions each have a size greater than or equal to 0.5 nm and less than or equal to 10 nm, preferably greater than or equal to 1 nm and less than or equal to 3 nm, or a similar size.

In addition, the CAC-OS has a composition in which materials are separated into a first region and a second region to form a mosaic pattern, and the first regions are distributed in the film. This composition is hereinafter also referred to as a cloud-like composition. That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide has [In] higher than that in the composition of the CAC-OS film. Moreover, the second region of the CAC-OS in the In—Ga—Zn oxide has [Ga] higher than that in the composition of the CAC-OS film. Alternatively, for example, the first region has higher [In] and lower [Ga] than the second region. Moreover, the second region has higher [Ga] and lower [In] than the first region.

Specifically, the first region includes indium oxide, indium zinc oxide, or the like as its main component. The second region includes gallium oxide, gallium zinc oxide, or the like as its main component. That is, the first region can be referred to as a region containing In as its main component. The second region can be referred to as a region containing Ga as its main component.

Note that a clear boundary between the first region and the second region cannot be observed in some cases.

For example, according to EDX mapping obtained by energy dispersive X-ray spectroscopy (EDX), the CAC-OS in the In—Ga—Zn oxide has a composition in which the region containing In as its main component (the first region) and the region containing Ga as its main component (the second region) are unevenly distributed and mixed.

In the case where the CAC-OS is used for a transistor, a switching function (on/off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Thus, when the CAC-OS is used for a transistor, high on-state current (Iₒₙ), high field-effect mobility (μ), and excellent switching operation can be achieved.

An oxide semiconductor can have any of various structures that show various different properties. Two or more of an amorphous oxide semiconductor, a polycrystalline oxide semiconductor, an a-like OS, the CAC-OS, an nc-OS, and the CAAC-OS may be included in an oxide semiconductor of one embodiment of the present invention.

The control circuit portion 1320 preferably uses a transistor using an oxide semiconductor because the transistor using an oxide semiconductor can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. On the other hand, the off-state current of the single crystal Si transistor largely depends on the temperature. For example, at 150° C., the off-state current of the single crystal Si transistor increases, and a sufficiently high current on/off ratio cannot be obtained. The control circuit portion 1320 can improve the degree of safety. When the control circuit portion 1320 is used in combination with a secondary battery having a positive electrode using the positive electrode active material 100 obtained in the foregoing embodiment, the synergy on safety can be obtained.

The control circuit portion 1320 that uses a memory circuit including a transistor using an oxide semiconductor can also function as an automatic control device for the secondary battery to resolve causes of instability, such as a micro-short circuit. Examples of functions of resolving the causes of instability include prevention of overcharge, prevention of overcurrent, control of overheating during charge, maintenance of cell balance of an assembled battery, prevention of overdischarge, a battery indicator, automatic control of charging voltage and current amount according to temperature, control of the amount of charge current according to the degree of deterioration, abnormal behavior detection for a micro-short circuit, and anomaly prediction regarding a micro-short circuit. The control circuit portion 1320 has at least one of these functions. Furthermore, the automatic control device for the secondary battery can be extremely small in size.

A micro-short circuit refers to a minute short circuit caused in a secondary battery. A micro-short circuit refers to not a state where the positive electrode and the negative electrode of a secondary battery are short-circuited so that charging and discharging are impossible, but a phenomenon in which a slight short-circuit current flows through a minute short-circuit portion. Since a large voltage change is caused even when a micro-short circuit occurs in a relatively short time in a minute area, the abnormal voltage value might adversely affect inference performed subsequently to estimate the charge and discharge state and the like of the secondary battery.

One of the supposed causes of a micro-short circuit is as follows. Uneven distribution of a positive electrode active material due to multiple charges and discharges causes local current concentration at part of the positive electrode and part of the negative electrode; thus, a malfunction of part of a separator is caused. Another supposed cause is generation of a by-product due to a side reaction.

It can be said that the control circuit portion 1320 not only detects a micro-short circuit but also detects a terminal voltage of the secondary battery and controls the charge and discharge state of the secondary battery. For example, to prevent overcharge, the control circuit portion 1320 can turn off an output transistor of a charging circuit and an interruption switch substantially at the same time.

FIG. 25B illustrates an example of a block diagram of the battery pack 1415 illustrated in FIG. 25A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range. When a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed with a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SiC), zinc selenide (ZnSe), gallium nitride (GaN), gallium oxide (GaOₓ, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using OS transistors can be stacked over the switch portion 1324 so that they can be integrated into one chip. Since the area occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system).

In this embodiment, an example in which lithium-ion secondary batteries are used as both the first battery 1301a and the second battery 1311 is described. As the second battery 1311, a lead storage battery, an all-solid-state battery, or an electric double layer capacitor may be used. For example, the all-solid-state battery in Embodiment 4 may be used. Using the all-solid-state battery in Embodiment 4 as the second battery 1311 achieves high capacity, a high degree of safety, and reduction in size and weight.

Regenerative energy generated by rolling of tires 1316 is transmitted to the motor 1304 through a gear 1305, and is stored in the second battery 1311 through a motor controller 1303, a battery controller 1302, and the control circuit portion 1321. Alternatively, the regenerative energy is stored in the first battery 1301a through the battery controller 1302 and the control circuit portion 1320. Alternatively, the regenerative energy is stored in the first battery 1301b through the battery controller 1302 and the control circuit portion 1320. For efficient charging with regenerative energy, the first batteries 1301a and 1301b are preferably capable of fast charging.

The battery controller 1302 can set the charging voltage, charge current, and the like of the first batteries 1301a and 1301b. The battery controller 1302 can set charge conditions in accordance with charging characteristics of a secondary battery used, so that fast charging can be performed.

Although not illustrated, when the electric vehicle is connected to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a plug of the charger or a connection cable of the charger is sometimes provided with a control circuit. The control circuit portion 1320 is also referred to as an electronic control unit (ECU). The ECU is connected to a controller area network (CAN) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet (50 kW), for example. Furthermore, charging can be performed by electric power supplied from external charging equipment with a contactless power feeding method or the like.

For fast charging, secondary batteries that can withstand charging at high voltage have been desired to perform charging in a short time.

The above-described secondary battery in this embodiment uses the positive electrode active material 100 obtained in the foregoing embodiment. Moreover, it is possible to achieve a secondary battery in which graphene is used as a conductive material, the electrode layer is formed thick to suppress a reduction in capacity while increasing the loading amount, and the electrical characteristics are significantly improved in synergy with maintenance of high capacity. This secondary battery is particularly effectively used in a vehicle and can achieve a vehicle that has a long range, specifically a driving range per charge of 500 km or longer, without increasing the proportion of the weight of the secondary batteries to the weight of the entire vehicle.

Specifically, in the secondary battery in this embodiment, the use of the positive electrode active material 100 described in the foregoing embodiment can increase the operating voltage, and the increase in charging voltage can increase the available capacity. Moreover, using the positive electrode active material 100 described in the foregoing embodiment in the positive electrode can provide an in-vehicle secondary battery having excellent cycle performance.

Next, examples in which the secondary battery of one embodiment of the present invention is mounted on a vehicle, typically a transport vehicle, will be described.

Mounting the secondary battery illustrated in any of FIG. 16D, FIG. 18C, and FIG. 25A on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can have high capacity. Thus, the secondary battery of one embodiment of the present invention is suitable for reduction in size and weight and is suitably used in transport vehicles.

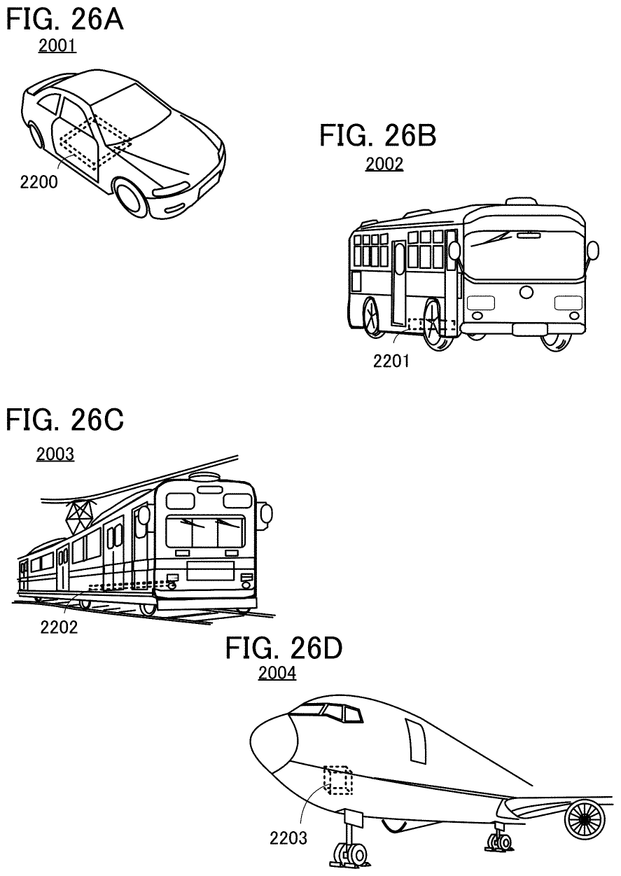

FIGS. 26A to 26D illustrate examples of transport vehicles as one example of vehicles using one embodiment of the present invention. An automobile 2001 illustrated in FIG. 26A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery exemplified in Embodiment 3 is provided at one position or several positions. The automobile 2001 illustrated in FIG. 26A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power through external charging equipment with a plug-in system, a contactless power feeding system, or the like. In charging, a given method such as CHAdeMO (registered trademark) or Combined Charging System can be employed as a charging method, the standard of a connector, and the like as appropriate. Charging equipment may be a charging station provided in a commerce facility or a power source in a house. For example, with the use of the plug-in system, the power storage device mounted on the automobile 2001 can be charged by being supplied with electric power from outside. The charging can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 26B illustrates a large transporter 2002 having a motor controlled by electricity as an example of a transport vehicle. A secondary battery module of the transporter 2002 includes a cell unit of four secondary batteries with a nominal voltage of 3.0 V or higher and 5.0 V or lower, for example, and 48 cells are connected in series to have a maximum voltage of 170 V. A battery pack 2201 has the same function as that in FIG. 26A except, for example, the number of secondary batteries configuring the secondary battery module; thus, the description is omitted.

FIG. 26C illustrates a large transportation vehicle 2003 having a motor controlled by electricity as an example. A secondary battery module of the transportation vehicle 2003 has 100 or more secondary batteries with a nominal voltage of 3.0 V or higher and 5.0 V or lower connected in series, and the maximum voltage is 600 V. With the use of the positive electrode using the positive electrode active material 100 described in the foregoing embodiment, a secondary battery having favorable rate characteristics and charge and discharge cycle performance can be fabricated, which can contribute to higher performance and a longer life of the transport vehicle 2003. A battery pack 2202 has the same function as that in FIG. 26A except, for example, the number of secondary batteries configuring the secondary battery module; thus, the description is omitted.

FIG. 26D illustrates an aircraft 2004 having a combustion engine as an example. The aircraft 2004 illustrated in FIG. 26D is regarded as one kind of transport vehicles because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series and has a maximum voltage of 32 V, for example. The battery pack 2203 has the same function as that in FIG. 26A except, for example, the number of secondary batteries configuring the secondary battery module; thus, the description is omitted.

The contents in this embodiment can be combined with any of the contents in the other embodiments as appropriate.

### Embodiment 7

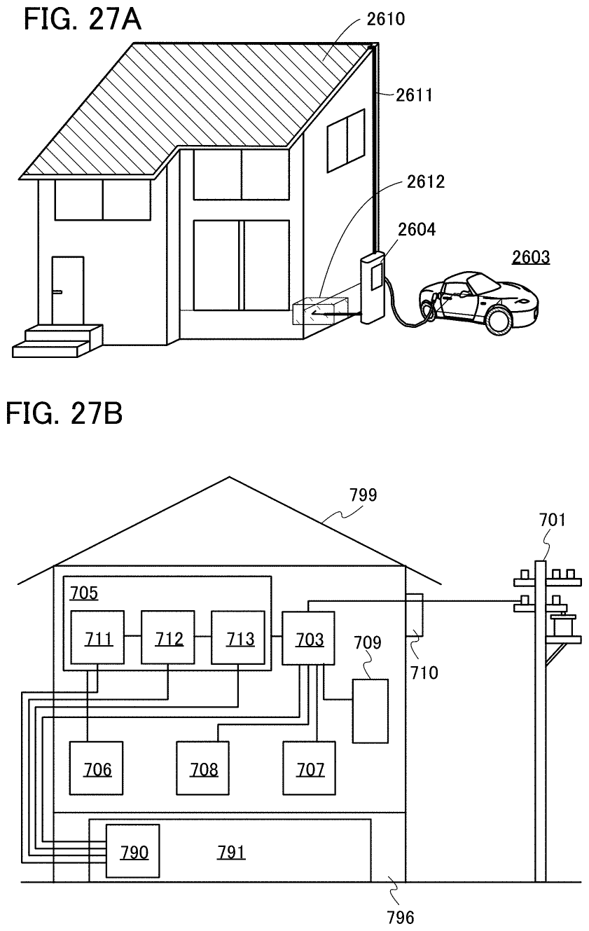

In this embodiment, examples in which the secondary battery of one embodiment of the present invention is mounted on a building will be described with reference to FIGS. 27A and 27B.

A house illustrated in FIG. 27A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charging device 2604. The power storage device 2612 can be charged with electric power generated by the solar panel 2610. A secondary battery included in a vehicle 2603 can be charged with the electric power stored in the power storage device 2612 through the charging device 2604. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, the electronic devices can be operated with the use of the power storage device 2612 of one embodiment of the present invention as an uninterruptible power source even when electric power cannot be supplied from the commercial power supply due to a power failure or the like.

FIG. 27B illustrates an example of a power storage device of one embodiment of the present invention. As illustrated in FIG. 27B, a power storage device 791 of one embodiment of the present invention is provided in an underfloor space 796 of a building 799. The power storage device 791 may be provided with the control circuit described in Embodiment 5, and the use of a secondary battery including a positive electrode using the positive electrode active material 100 obtained in the foregoing embodiment enables the power storage device 791 to have a long lifetime.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electrical device such as a TV or a personal computer. The power storage load 708 is, for example, an electrical device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may also have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The indicator 706 can show the amount of electric power consumed by the general load 707 and the power storage load 708 that is measured by the measuring portion 711. An electrical device such as a TV or a personal computer can also show it through the router 709. Furthermore, a portable electronic terminal such as a smartphone or a tablet can also show it through the router 709. The indicator 706, the electrical device, and the portable electronic terminal can also show, for example, the demand for electric power depending on a time period (or per hour) that is predicted by the predicting portion 712.

The contents in this embodiment can be combined with any of the contents in the other embodiments as appropriate.

### Embodiment 8

This embodiment will describe examples in which the power storage device of one embodiment of the present invention is mounted on a motorcycle and a bicycle.

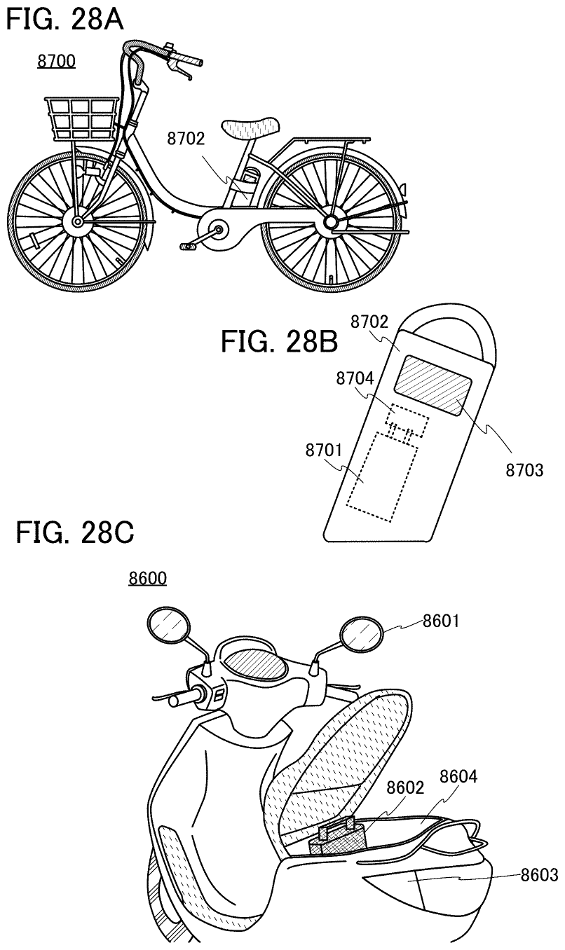

FIG. 28A illustrates an example of an electric bicycle using the power storage device of one embodiment of the present invention. The power storage device of one embodiment of the present invention can be used for an electric bicycle 8700 in FIG. 28A. The power storage device of one embodiment of the present invention includes a plurality of storage batteries and a protection circuit, for example.

The electric bicycle 8700 is provided with a power storage device 8702. The power storage device 8702 can supply electric power to a motor that assists a rider. The power storage device 8702 is portable, and FIG. 28B shows the state where the power storage device 8702 is removed from the electric bicycle. The power storage device 8702 incorporates a plurality of storage batteries 8701 included in the power storage device of one embodiment of the present invention, and can display the remaining battery level and the like on a display portion 8703. The power storage device 8702 includes a control circuit 8704 capable of charge control or anomaly detection for the secondary battery, which is exemplified in Embodiment 5. The control circuit 8704 is electrically connected to a positive electrode and a negative electrode of the storage battery 8701. The control circuit 8704 may include the small solid-state secondary battery illustrated in FIGS. 24A and 24B. When the small solid-state secondary battery illustrated in FIGS. 24A and 24B is provided in the control circuit 8704, electric power can be supplied to store data in a memory circuit included in the control circuit 8704 for a long time. When the control circuit 8704 is used in combination with a secondary battery having a positive electrode using the positive electrode active material 100 obtained in the foregoing embodiment, the synergy on safety can be obtained. The secondary battery having the positive electrode using the positive electrode active material 100 obtained in the foregoing embodiment and the control circuit 8704 can contribute greatly to elimination of accidents due to secondary batteries, such as fires.

FIG. 28C illustrates an example of a motorcycle using the power storage device of one embodiment of the present invention. An electric motorcycle 8600 illustrated in FIG. 28C includes a power storage device 8602, side mirrors 8601, and indicators 8603. The power storage device 8602 can supply electric power to the indicators 8603. The power storage device 8602 including a plurality of secondary batteries having a positive electrode using the positive electrode active material 100 obtained in the foregoing embodiment can have high capacity and contribute to a reduction in size.

In the electric motorcycle 8600 illustrated in FIG. 28C, the power storage device 8602 can be held in an under-seat storage unit 8604. The power storage device 8602 can be held in the under-seat storage unit 8604 even with a small size.

The contents in this embodiment can be combined with any of the contents in the other embodiments as appropriate.

### Embodiment 9

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

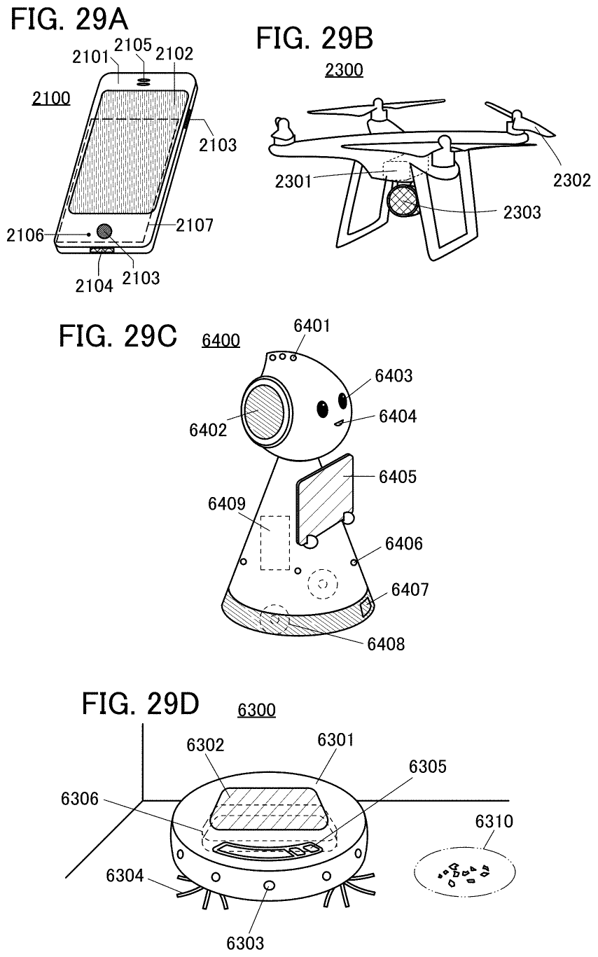

FIG. 29A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 having a positive electrode using the positive electrode active material 100 described in the foregoing embodiment achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on a communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without via the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 29B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 100 obtained in the foregoing embodiment has a high energy density and a high degree of safety, and thus can be used safely for a long time over a long period of time and is suitable for the secondary battery included in the unmanned aircraft 2300.

FIG. 29C illustrates an example of a robot. A robot 6400 illustrated in FIG. 29C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of the user, an environmental sound, and the like. The speaker 6404 has a function of outputting sound. The robot 6400 can use the microphone 6402 and the speaker 6404 to communicate with the user.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking images of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 100 obtained in the foregoing embodiment has a high energy density and a high degree of safety, and thus can be used safely for a long time over a long period of time and is suitable for the secondary battery 6409 included in the robot 6400.

FIG. 29D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the secondary battery 6306 of one embodiment of the present invention and a semiconductor device or an electronic component. A secondary battery including a positive electrode using the positive electrode active material 100 obtained in the foregoing embodiment has a high energy density and a high degree of safety, and thus can be used safely for a long time over a long period of time and is preferable as the secondary battery 6306 included in the cleaning robot 6300.

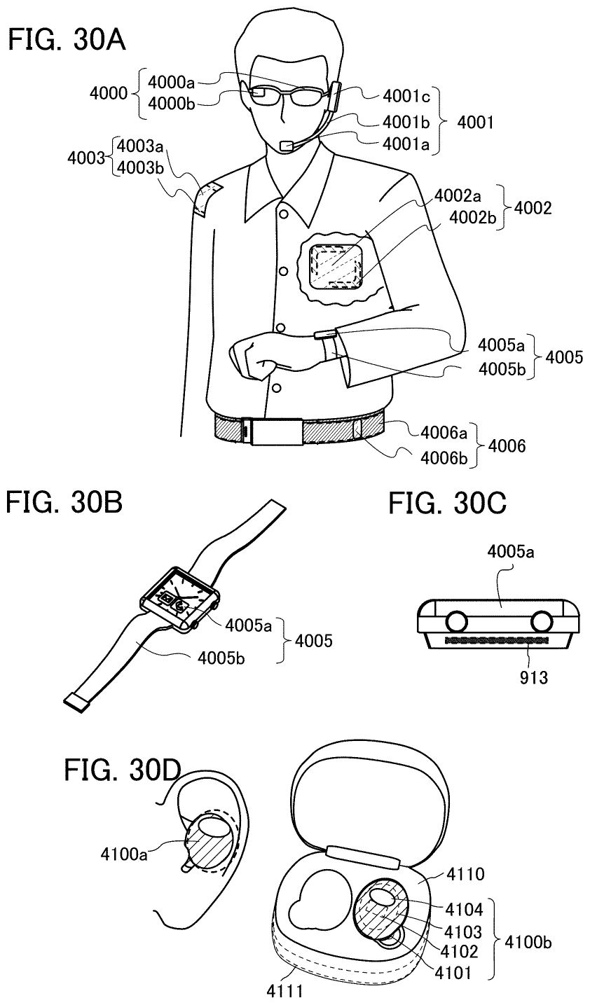

FIG. 30A illustrates examples of wearable devices. A secondary battery is used as a power source of a wearable device. To have improved splash resistance, water resistance, or dust resistance in daily use or outdoor use by the user, a wearable device is desirably capable of wireless charging as well as wired charging, for which a connector is exposed.

For example, the secondary battery of one embodiment of the present invention can be provided in a glasses-type device 4000 illustrated in FIG. 30A. The glasses-type device 4000 includes a frame 4000a and a display portion 4000b. The secondary battery is provided in a temple of the frame 4000a having a curved shape, whereby the glasses-type device 4000 can be lightweight, can have a well-balanced weight, and can be used continuously for a long time. A secondary battery including a positive electrode using the positive electrode active material 100 obtained in the foregoing embodiment has a high energy density and achieves a structure that accommodates space saving due to a reduction in size of the housing.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b or the earphone portion 4001c. A secondary battery including a positive electrode using the positive electrode active material 100 obtained in the foregoing embodiment has a high energy density and achieves a structure that accommodates space saving due to a reduction in size of the housing.

The secondary battery of one embodiment of the present invention can be provided in a device 4002 that can be attached directly to a body. A secondary battery 4002b can be provided in a thin housing 4002a of the device 4002. A secondary battery including a positive electrode using the positive electrode active material 100 obtained in the foregoing embodiment has a high energy density and achieves a structure that accommodates space saving due to a reduction in size of the housing.

The secondary battery of one embodiment of the present invention can be provided in a device 4003 that can be attached to clothes. A secondary battery 4003b can be provided in a thin housing 4003a of the device 4003. A secondary battery including a positive electrode using the positive electrode active material 100 obtained in the foregoing embodiment has a high energy density and achieves a structure that accommodates space saving due to a reduction in size of the housing.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. A secondary battery including a positive electrode using the positive electrode active material 100 obtained in the foregoing embodiment has a high energy density and achieves a structure that accommodates space saving due to a reduction in size of the housing.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. A secondary battery including a positive electrode using the positive electrode active material 100 obtained in the foregoing embodiment has a high energy density and achieves a structure that accommodates space saving due to a reduction in size of the housing.

The display portion 4005a can display various kinds of information such as time and reception information of an e-mail and an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 30B is a perspective view of the watch-type device 4005 that is detached from an arm.

FIG. 30C is a side view of the watch-type device 4005. FIG. 30C illustrates a state where the secondary battery 913 is incorporated in the inner region. The secondary battery 913 is the secondary battery described in Embodiment 3. The secondary battery 913 is provided to overlap the display portion 4005a, can have a high density and high capacity, and is small and lightweight.

Since the secondary battery in the watch-type device 4005 is required to be small and lightweight, the use of the positive electrode active material 100 obtained in the foregoing embodiment in the positive electrode enables the secondary battery 913 to have a high energy density and a small size.

FIG. 30D illustrates an example of wireless earphones. Here, the wireless earphones including a pair of main bodies 4100a and 4100b are illustrated; however, a pair of main bodies are not always necessary.

Each of the main bodies 4100a and 4100b includes a driver unit 4101, an antenna 4102, and a secondary battery 4103. Each of the main bodies 4100a and 4100b may also include a display portion 4104. Moreover, each of the main bodies 4100a and 4100b preferably includes a substrate where a circuit such as a wireless IC is provided, a terminal for charging, and the like. Each of the main bodies 4100a and 4100b may also include a microphone.

A case 4110 includes a secondary battery 4111. Moreover, the case 4110 preferably include a substrate where a circuit such as a wireless IC or a charge control IC is provided, and a terminal for charging. The case 4110 may also include a display portion, a button, and the like.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main body 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery including a positive electrode using the positive electrode active material 100 obtained in the foregoing embodiment has a high energy density; thus, using the secondary battery as the secondary battery 4111 and the secondary battery 4103 can achieve a structure that accommodates space saving due to a reduction in size of the wireless earphones.

This embodiment can be combined with any of the other embodiments as appropriate.

### Example

In this example, a positive electrode active material of one embodiment of the present invention was formed and its characteristics were analyzed.

First, a method for manufacturing the positive electrode active material is described with reference to FIG. 1, FIG. 2, FIG. 3, FIG. 4, FIG. 5, FIG. 6, FIG. 7, and FIG. 8.

### <Sample 1>

As the nickel source, a nickel(II) sulfate as the nickel source, cobalt(II) sulfate as the cobalt source, and manganese(II) sulfate as the manganese source were used, weighed at the molar ratio of Ni:Co:Mn=8:1:1, and dissolved in water to obtain a 2M solution. To the solution was added 0.075M glycine as a chelate agent to give an acid solution.

A 5M sodium hydroxide solution was used as an alkaline solution.

As a filling liquid, a 0.075M glycine aqueous solution was used. Nitrogen was bubbled in the filling liquid at the nitrogen flow rate of 1 L/min.

While the filling liquid was stirred at 1000 rpm, the acid solution was dropped thereto. The dropping amount was increased from 0.40 mL/min to 0.93 mL/min. The alkaline solution was dropped appropriately to maintain the pH of the filling liquid at 10.3. The temperature of the filling liquid was kept at 70° C. OptiMax by3 Mettler-Toledo. K. K. was used for the coprecipitation reaction.

A precipitate generated in the coprecipitation reaction was filtered with pure water and acetone, and dried to give a composite hydroxide.

A lithium hydroxide monohydrate was used as the lithium source and mixed with the composite hydroxide obtained before. The mixing ratio of lithium to the total of nickel, cobalt, and manganese was 1.01 at the molar ratio, when the total of nickel, cobalt, and manganese was 1.

The mixture was heated in an oxygen atmosphere in a muffle furnace with use of an aluminum oxide crucible at 500° C. for 10 hours. The flow rate of oxygen was 5 L/min. The temperature was cooled down to room temperature, and crushing was performed to give a composite oxide.

The composite oxide obtained in the above-described manner was similarly heated at 800° C. for 10 hours. A comparative example was fabricated without using an additive element in this manner and this sample was Sample 1.

### <Sample 2>

Gallium was added to Sample 2 in Step S12. Specifically, gallium(III) sulfate was used as the gallium source; nickel, cobalt, manganese, and gallium were weighed at the molar ratio of Ni:Co:Mn:Ga=80:10:9:1, and were dissolved in water to obtain a 2M solution. Glycine was added to the solution to obtain an acid solution. The mixing amount of the acid solution was increased from 0.20 mL/min to 0.47 mL/min. The other steps were performed in a similar manner to Sample 1. In other words, the lithium source was added, the mixture was heated at 500° C. for 10 hours, and further heated at 800° C. for 10 hours.

### <Sample 3>

In Sample 3, the same composite hydroxide as the composite hydroxide used in Sample 1 was used and gallium was added in Step S41. Specifically, a gallium oxyhydroxide was used as the gallium source, and the gallium source and the lithium source were mixed to the composite hydroxide obtained in a similar manner to that in Sample 1. The mixing ratio of gallium to the total of nickel, cobalt, and manganese was 0.01 at the molar ratio, when the total of nickel, cobalt, and manganese was 1. The other steps were performed in a similar manner to Sample 1. In other words, the lithium source and the gallium source were added, the mixture was heated at 500° C. for 10 hours, and further heated at 800° C. for 10 hours.

### <Sample 4>

In Sample 4, the same composite hydroxide as the composite hydroxide used in Sample 1 was used and gallium was added in Step S61. Specifically, a gallium oxyhydroxide was used as the gallium source, and the gallium source was mixed to the composite hydroxide obtained in a similar manner to that in Sample 1. The mixing ratio of gallium to the total of nickel, cobalt, and manganese was 0.01 at the molar ratio, when the total of nickel, cobalt, and manganese was 1. Specifically, the lithium source was added, the mixture was heated at 500° C. for 10 hours, and then heated at 800° C. for 10 hours. Furthermore, the gallium source was added and the mixture was further heated at 800° C. for 2 hours. The other steps were performed in a similar manner to Sample 1.

### <Sample 11>

Sample 11 was fabricated in a similar manner to Sample 1.

### <Sample 12>

In Sample 12, aluminum was added in Step S12. Specifically, aluminum sulfate was used as the aluminum source, and nickel, cobalt, manganese, and aluminum were weighed at the molar ratio of Ni:Co:Mn:Al=79:10:10:1, and dissolved in water to obtain a 2M solution. Glycine was added to obtain an acid solution. The dropping amount of the acid solution was 0.8 L/min. The other steps were performed in a similar manner to Sample 2.

### <Sample 13>

In Sample 13, the same composite hydroxide as the composite hydroxide used in Sample 11 was used and aluminum was added in Step S41. Specifically, aluminum hydroxide was used as the aluminum source, and the aluminum source and the lithium source were mixed to the composite hydroxide obtained in a similar manner to Sample 1. The mixing ratio of aluminum to the total of nickel, cobalt, and manganese was 0.01 at the molar ratio, when the total of nickel, cobalt, and manganese was 1. The other steps were performed in a similar manner to Sample 3.

### <Sample 14>

In Sample 14, the same composite hydroxide as the composite hydroxide used in Sample 11 was used and aluminum was added in Step S61. Specifically, aluminum hydroxide was used as the aluminum source, and the aluminum source was mixed to the composite hydroxide obtained in a similar manner to Sample 1. The mixing ratio of aluminum to the total of nickel, cobalt, and manganese was 0.01 at the molar ratio, when the total of nickel, cobalt, and manganese was 1. The other steps were performed in a similar manner to Sample 4.

Conditions for manufacturing Samples 1 to 4 and Samples 11 to 14 are shown in Table 4.

TABLE 4

| | | | Dishcarge |
|---|---|---|---|
| | Additive | Timing of | capacity (max.) |
| | elemnet | adding | (mAh/g) |
| Sample 1 | N/A | — | 219.5 |
| Sample 2 | Ga | S12 | 214.5 |
| Sample 3 | Ga | S42 | 213.9 |
| Sample 4 | Ga | S61 | 210.5 |
| Sample 11 | N/A | — | 214.0 |
| Sample 12 | Al | S12 | 216.5 |
| Sample 13 | Al | S42 | 218.9 |
| Sample 14 | Al | S61 | 217.2 |

### <SEM>

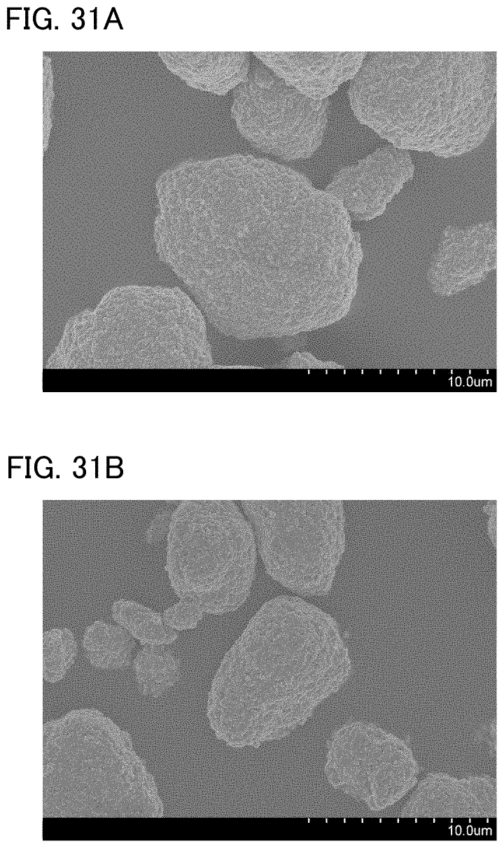

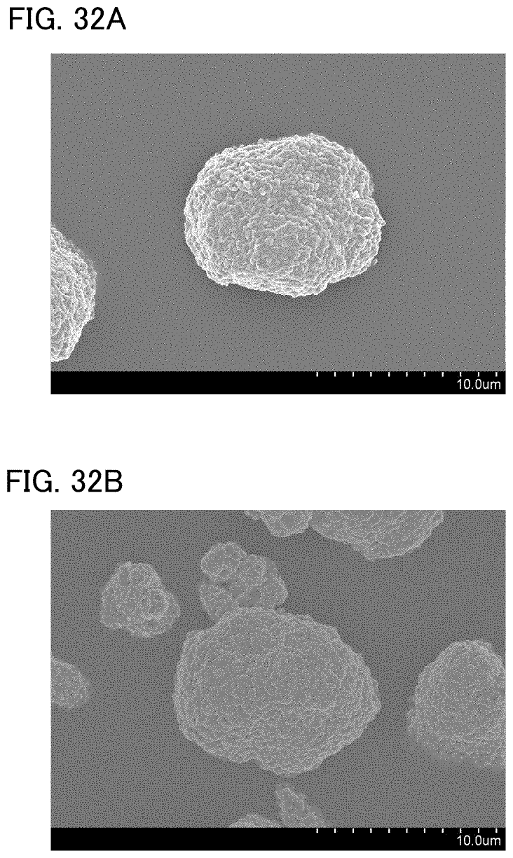

FIGS. 31A, 31B, 32A, and 32B show SEM images of Samples 1, 2, 3, and 4, respectively. The positive electrode active materials were the secondary particles.

### <Cycle Characteristics>

Half-cells were assembled in the following manner using the positive electrode active materials obtained above.

Acetylene black (AB) was prepared as a conductive material, and polyvinylidene fluoride (PVDF) was prepared as a binder. Then, the positive electrode active material, AB, and PVDF were mixed in a weight ratio of the positive electrode active material:AB:PVDF=95:3:2 to prepare a slurry, and the slurry was applied on an aluminum current collector. As a solvent of the slurry, N-methyl-2-pyrrolidone (NMP) was used.

After the current collector was coated with the slurry, the solvent was volatilized, followed by pressing. Through the above steps, the positive electrode was obtained. In the positive electrode, the loading level of the active material was approximately 7 mg/cm².

As an electrolyte solution, a mixture of ethylene carbonate (EC) and diethyl carbonate (DEC) at a volume ratio of EC:DEC=3:7 to which vinylene carbonate (VC) was added as an additive agent at 2 wt % was used. As an electrolyte contained in the electrolyte solution, 1 mol/L lithium hexafluorophosphate (LiPF₆) was used. As a separator, polypropylene was used.

A lithium metal was prepared as a counter electrode. Thus, coin-type half cells including the above positive electrodes and the like were fabricated. Their charge-discharge cycle performance was measured.

Charge was performed at constant current (CC) and constant voltage (CV) (100 mA/g, 4.5 V, 10 mA/g cutoff) and discharge performed at constant current (CC) (100 mA/g 2.7 V cutoff). A ten-minute pause was given between charge and discharge. The measurement temperature of each cell was 45° C.

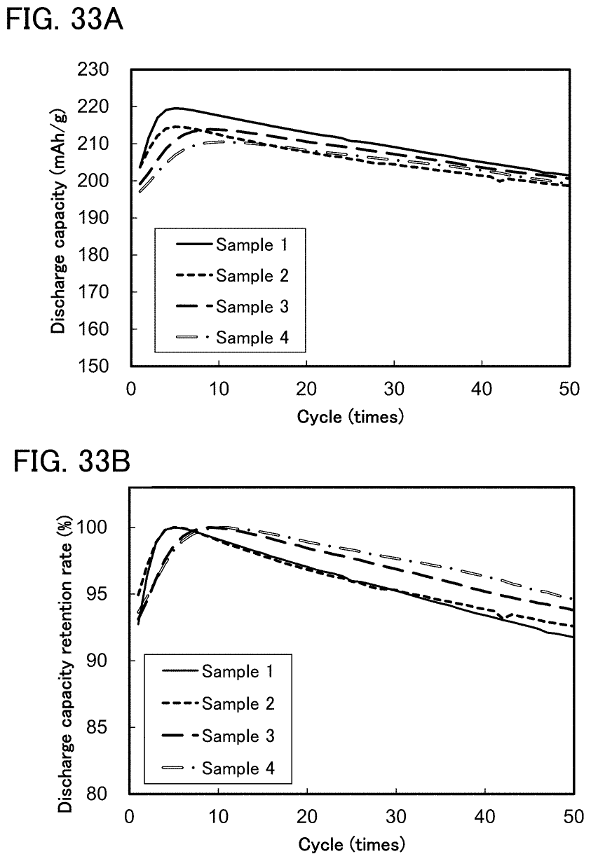

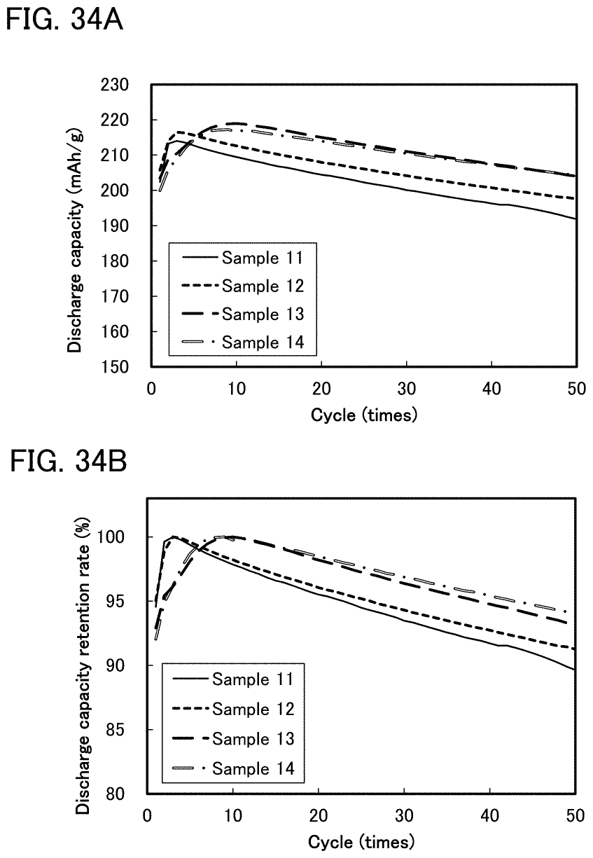

FIGS. 33A and 33B show discharge capacities and discharge capacity retention rates of Samples 1 to 4, respectively. FIGS. 34A and 34B show discharge capacities and discharge capacity retention rates of Samples 11 to 14, respectively. The maximum discharge capacity is also shown in Table 4.

As shown in FIGS. 33A, 33B, 34A, and 34B, Samples 2 to 4 and Samples 12 to 14 exhibited excellent cycle performance even at the relatively high measurement temperature 45° C. In particular, the sample in which the additive element was mixed in Step S61 has the most excellent discharge capacity retention rate. The discharge capacity retention rates after 50 cycles was 94.6% in Sample 4 and 94.0% in Sample 14.

This application is based on Japanese Patent Application Serial No. 2021-017119 filed with Japan Patent Office on Feb. 5, 2021, the entire contents of which are hereby incorporated by reference.

What is claimed is:

1. A method for manufacturing a positive electrode active material, comprising the steps of:
forming a composite hydroxide containing nickel, cobalt, and manganese by a reaction between an aqueous solution containing nickel, cobalt, and manganese and an alkaline solution;
forming a mixture by mixing the composite hydroxide, a lithium source, and a first additive element source; and
heating the mixture to form a composite oxide,
wherein the first additive element source comprises a first additive element, and
wherein the first additive element is at least one of gallium, boron, aluminum, indium, magnesium, and fluorine.

2. The method for manufacturing a positive electrode active material, according to claim 1,
wherein the first additive element is gallium,
wherein the first additive element source is gallium hydroxide, gallium oxyhydroxide, or an organic acid salt of gallium.

3. The method for manufacturing a positive electrode active material, according to claim 1, wherein the step of heating the mixture is performed at a temperature higher than or equal to 400° C. and lower than or equal to 700° C.

4. The method for manufacturing a positive electrode active material, according to claim 3, the method further comprising the step of:
heating the composite oxide,
wherein the step of heating the composite oxide is performed at a temperature higher than 700° C. and lower than or equal to 1050° C.

5. A secondary battery comprising the positive electrode active material manufactured by the method according to claim 1.

6. A vehicle comprising:
the secondary battery according to claim 5; and
at least one of a motor, a brake, and a control circuit.

7. A method for manufacturing a positive electrode active material, comprising the steps of:
forming a composite hydroxide containing nickel, cobalt, and manganese by a reaction between an aqueous solution containing nickel, cobalt, and manganese and an alkaline solution;
forming a first mixture by mixing the composite hydroxide and a lithium source;
heating the first mixture to form a composite oxide;
forming a second mixture by mixing the composite oxide and a first additive element source; and
heating the second mixture,
wherein the first additive element source comprises a first additive element, and
wherein the first additive element is at least one of calcium, gallium, boron, aluminum, indium, magnesium, and fluorine.

8. The method for manufacturing a positive electrode active material, according to claim 7,
wherein the step of heating the second mixture is performed at a temperature higher than 750° C. and lower than or equal to 850° C.

9. The method for manufacturing a positive electrode active material, according to claim 7,
wherein the step of heating the first mixture is performed at a temperature higher than or equal to 400° C. and lower than or equal to 700° C. and then is performed at a temperature higher than 700° C. and lower than or equal to 1050° C.

10. The method for manufacturing a positive electrode active material, according to claim 7,
wherein the first additive element is gallium, and
wherein a compound containing the first additive element is gallium hydroxide, gallium oxyhydroxide, or an organic acid salt of gallium.

11. A secondary battery comprising the positive electrode active material manufactured by the method according to claim 7.

12. A vehicle comprising:
the secondary battery according to claim 11; and
at least one of a motor, a brake, and a control circuit.

13. A method for manufacturing a positive electrode active material, comprising the steps of:
forming a composite hydroxide containing nickel, cobalt, manganese, and a first additive element by a reaction between an aqueous solution containing nickel, cobalt, manganese, and the first additive element and an alkaline solution;
forming a mixture by mixing the composite hydroxide and a lithium source;
heating the mixture to form a composite oxide; and
heating the composite oxide,
wherein the first additive element is at least one of calcium, gallium, boron, aluminum, indium, magnesium, and fluorine.

14. The method for manufacturing a positive electrode active material, according to claim 13,
wherein the step of heating the mixture is performed at a temperature higher than or equal to 400° C. and lower than or equal to 700° C., and
wherein the step of heating the composite oxide is performed at a temperature higher than 700° C. and lower than or equal to 1050° C.

15. A secondary battery comprising the positive electrode active material manufactured by the method according to claim 13.

16. A vehicle comprising:
the secondary battery according to claim 15; and
at least one of a motor, a brake, and a control circuit.

17. A method for manufacturing a positive electrode active material, comprising the steps of:
forming a composite hydroxide containing nickel, cobalt, manganese, and a first additive element by a reaction between an aqueous solution containing nickel, cobalt, manganese, and the first additive element and an alkaline solution;
forming a first mixture by mixing the composite hydroxide and a lithium source;
heating the first mixture to form a composite oxide;
forming a second mixture by mixing the composite oxide and a second additive element source; and
heating the second mixture,
wherein the first additive element is at least one of gallium, boron, aluminum, indium, magnesium, and fluorine,
wherein the second additive element source comprises a second additive element, and
wherein the second additive element is at least one of calcium, gallium, boron, aluminum, indium, magnesium, and fluorine.

18. The method for manufacturing a positive electrode active material, according to claim 17,
wherein the step of heating the second mixture is performed at a temperature higher than 750° C. and lower than or equal to 850° C.

19. The method for manufacturing a positive electrode active material, according to claim 17,
wherein the first additive element is gallium,
wherein a first additive element source is gallium hydroxide, gallium oxyhydroxide, or an organic acid salt of gallium,
wherein the second additive element is calcium, and
wherein the second additive element source is calcium carbonate or calcium fluoride.

20. The method for manufacturing a positive electrode active material, according to claim 17,
wherein the first additive element is aluminum, and
wherein the second additive element is calcium.

21. A secondary battery comprising the positive electrode active material manufactured by the method according to claim 17.

22. A vehicle comprising:
the secondary battery according to claim 21; and
at least one of a motor, a brake, and a control circuit.
